(19) United States
(12) Patent Application Publication
(10) Pub. No.: US 2025/0177932 A1
(43) Pub. Date: Jun. 5, 2025

(54) MIXER HAVING DIFFERENT DIAMETERS FOR APPLICATOR FOR PRODUCING MULTIPLE COMPONENT MIXTURE

(71) Applicant: Atlas Copco IAS GmbH, Bretten (DE)

(72) Inventors: Gerrit ENDERLE, Knittlingen (DE); Andreas HOIBL, Pentling (DE)

(21) Appl. No.: 18/959,537

(22) Filed: Nov. 25, 2024

(30) Foreign Application Priority Data
Nov. 28, 2023 (DE) 10 2023 133 278.3

(51) Int. Cl. B01F 25/31; B01F 23/235; B01F 35/21; B01F 35/222

(52) U.S. Cl. CPC B01F 25/3111; B01F 23/235; B01F 35/2113; B01F 35/222

(57) ABSTRACT

The disclosure relates to an application device for mixing a plurality of components for producing a multicomponent mixture, in particular a polyurethane foam, and for introducing and/or applying the multicomponent mixture into and/or onto an object, in particular a lithium-ion battery, comprising: a mixing tube with a first closed end and a second end for discharging the multicomponent mixture from the mixing tube, wherein the mixing tube has a mixing chamber and a plurality of sections, wherein a wall of the mixing tube of at least two of the plurality of sections has mutually different internal diameters, further comprising a plurality of injection units, which are each configured to inject a corresponding one of the plurality of components into the mixing chamber, and a mixer arranged in the mixing chamber, which mixer is configured to mix the injected components with one another along the mixing tube. Furthermore disclosed is an application system comprising the application device.

### CROSS-REFERENCE TO RELATED APPLICATIONS

This application claims priority to German Patent Application No. 10 2023 133 278.3, filed on Nov. 28, 2023, which is incorporated by reference herein in its entirety.

### BACKGROUND

The invention relates to an application device for producing a multicomponent mixture, in particular a polyurethane foam, and for introducing/applying the multicomponent mixture into/onto an object, in particular during battery production, e.g. lithium-ion batteries, and an application system comprising the application device.

In the production of foams, one or more components are mixed with air, for example. Here, precise, reproducible and uniform mixing of the component itself and of the component with air is important. This includes the fact that the mass or volume ratio of the components to one another, and in particular to the air, in the foam can be set precisely to an optimum value and has to be maintained continuously during the entire production of the foam. In addition, the mixture has to be homogeneous in the entire foam volume. The foam has to be able to be produced reproducibly over a plurality of production batches.

Poorly flammable foams are used for fire protection, for example in the case of batteries, and for insulation in the construction sector. Fire protection also plays an important role in the insulation. Here, the specified specifications for foam production are particularly important.

Lithium-based batteries, in particular lithium-ion batteries, are used, for example, for electric vehicles. Particularly frequently, such lithium-ion batteries are used for storing energy which has been generated using PV systems. However, lithium-ion batteries are also used in many other sectors for storing energy, in particular since their durability is very long. However, the use of lithium-ion batteries is not without problems.

Fire protection plays an extremely important role in the case of lithium-ion batteries, since lithium-ion batteries have a very destructive fire behavior and are difficult to extinguish. For preventive fire protection in the case of lithium-ion batteries, there are currently few practicable and/or only inadequately functioning solutions. These solutions include the application of fire protection material to a cover or housing of the battery, the provision of a honeycomb structure in the battery or the complete pouring out of the battery or of the battery cells of the battery.

A new type of fire protection is the use of polyurethane (“PU” for short) foams. For this purpose, the battery is foamed with a PU foam. In this case, the battery cells are surrounded with PU foam. If a defective battery cell burns or becomes thermally uncontrollable, the PU foam absorbs the heat arising in the process and prevents the adjacent battery cells also from overheating or starting to burn by the PU foam melting. This prevents a fire from arising or expanding rapidly. The PU foam thus prevents the entire electric vehicle or the entire house from burning off as a result of a defective battery cell.

Two monomers (for example a polyol and a polyisocyanate) are used for the production (polymerization) of PU foam. The foaming can take place chemically and/or physically.

Conventional solutions for the production and application of foam, in particular PU foam, have the disadvantage that an uninterrupted conveyance of the components or an uninterrupted production of the foam is not possible. To date, the components have in each case been preconditioned or prepared in a tank and, if appropriate, already mixed with air in the tank. The plurality of components were then fed to a mixer and/or applicator. The component tank has to be replaced regularly or loaded with new material. Furthermore, it is not possible to set precisely the mixing ratio of the components in the foam since the components are already fed to the mixer or applicator in an air-displaced state. Therefore, the metering of the components is inaccurate and the ratio between the components among one another, and in particular the ratio between air and the other components, cannot be set or can be set only with difficulty. Furthermore, the mixer or applicator drips after a stop of the foam production.

Unsolved is therefore the problem of how a material quality of the foam and a mixing quality can be increased. In particular, unsolved is how a foam can be produced and applied in a clean, precise, reproducible, homogeneous and efficient manner.

### SUMMARY OF THE INVENTION

It is an object of the invention to improve an application device and an application system for producing and introducing/applying a multicomponent mixture, in particular PU foam, into/onto an object, in particular a lithium-ion battery. It is also an object of the invention to improve a method for producing and introducing/applying a multicomponent mixture, in particular PU foam, into/onto an object, in particular a lithium-ion battery.

It is an object of the invention to increase the efficiency in the production and introduction/application of PU foam. In particular, it is an object of the invention to enable an uninterrupted production and introduction/application of PU foam.

It is an object of the invention to improve a homogeneity, controllability and precision in the production and introduction/application of PU foam. In particular, it is an object of the invention to improve the precision of a mixing ratio of the components, including air, of the PU foam.

It is an object of the invention to improve the cleanliness in the introduction/application of PU foam. Furthermore, it is an object of the invention to increase the flexibility in the use of different components for producing the PU foam.

The objects are formulated by way of example for PU foam and the use thereof for batteries. However, the disclosure is not restricted thereto and can be used generally in the production and application of multicomponent mixtures and/or foams composed of one or more components which are mixed with air. The use in batteries is also mentioned here merely by way of example. Such multicomponent mixtures and foams can be used in different sectors, for example in the production of building materials.

At least one of the objects is achieved by the subject matter of the independent claims. Advantageous embodiments and developments emerge from the subject matter of the dependent claims.

In the context of the disclosure, “application to an article” is to be regarded as synonymous with “application to an article”. Embodiments of the disclosure are described with reference to the application of a multicomponent mixture to an article. This is also intended to cover the case in which the multicomponent mixture is introduced into the article. In the context of the disclosure, a “battery” is to be regarded as synonymous with an “accumulator”. An “application device” may also be referred to in short as an “applicator” and constitutes a device for applying or applying a mixture. In the context of this disclosure, a “mixture” is to be understood as synonymous with “mixture”. A multicomponent mixture refers to the mixture of a first component with at least one further component, in particular a gas or a gas mixture, for example air. A foam refers to a multicomponent mixture composed of a first component and, as a second component, composed of a gas or gas mixture, in particular air, and optionally composed of further components. Unless stated otherwise, a “component” refers to a material. The specification of different components serves to distinguish different materials. In the context of this disclosure, polymerized polyurethane may also be referred to as a multicomponent mixture.

As a result of the stated invention, all the components, including, if appropriate, the gas or gas mixture, are mixed with a mixer only in the application device.

As a result of the stated invention, a mixing tube with different internal diameters is provided. The different internal diameters result in different rotational speeds of the material of the components along the mixing tube during the mixing of the components in the mixing space by means of the mixer. This enables a more flexible mixing of the components and an improved mixing, in particular an increased homogeneity of the mixing.

Furthermore, by means of embodiments of the disclosure, a mixing section is defined along the mixing tube with a closed end and an open end. By means of the mixing section, a sequence is predefined on the basis of which the plurality of components for the production of the multicomponent mixture are injected into the mixing space and mixed with one another. In this case, it can be ensured on the one hand that the sequence of mixing of the components is adhered to.

Furthermore, this sequence can be made flexible by varying one or more positions at which the one or more components are injected into the mixing space. Furthermore, the type of the injected components can be changed in a simple manner and the components injected at the corresponding positions can be replaced. As a result, different multicomponent mixtures can be produced in a simple manner. Furthermore, by setting the material flow of the injected components, a mass or volume ratio of the injected or mixed components can be set in a simple manner. In particular, a ratio between the first component/third component and gas or air can be set precisely, as a result of which the material quality of the multicomponent mixture and/or a mixing quality can be increased.

Furthermore, a prepared or stirred material of the first or third component can be provided by devices for material treatment which are connected upstream in a corresponding manner to the mixer. As a result, the material always has the same material properties before it is injected into the mixing space. In particular, a homogeneity of the injected components can be increased. As a result, a material quality of the multicomponent mixture and a mixing quality can likewise be increased. Furthermore, effects such as so-called “sacking” are prevented.

By means of embodiments of the disclosure, it is furthermore achieved that the second, open end of the mixing tube can be closed in a rapidly simple manner by the movement of the mixer along the mixing tube. As a result, an emergence of the multicomponent mixture from the mixing tube can be effectively prevented. This is advantageous in particular when the application of the multicomponent mixture to the article is intended to be ended. Furthermore, a dripping of the multicomponent mixture from the application device can be prevented. As a result, a clean application of the multicomponent mixture can be ensured.

By means of embodiments of the disclosure, it is furthermore achieved that the first component and the third component are mixed with gas only in the mixing space of the application device. As a result, these components can be metered in a gas-free or air-free state and injected into the mixing space. Therefore, a metering is no longer dependent on an amount or a volume of gas which is contained in the components. In particular, the gas volume would be highly dependent on a pressure in the lines which conduct the components. As a result, the accuracy during metering is significantly increased. As a result, in turn, a ratio between the first component or third component and gas, in particular air, can be set and regulated precisely. As a result, a material quality of the multicomponent mixture and a mixing quality can be increased.

According to a first aspect of the disclosure, an application device for mixing a plurality of components for producing a multicomponent mixture and for introducing and/or applying the multicomponent mixture into and/or onto an object is specified.

The application device comprises a mixing tube with a first closed end and a second end for discharging the multicomponent mixture from the mixing tube. The mixing tube can comprise a mixing space between the first end and the second end.

The mixing tube has a plurality of sections, wherein a wall of the mixing tube of at least two of the plurality of sections has mutually different internal diameters. The plurality of sections can be arranged along the mixing tube. The wall of the mixing tube can have mutually different internal diameters in or between at least two of the plurality of sections. The wall in one of the sections can have a different internal diameter than an internal diameter of the wall in at least one other of the plurality of sections. The wall of the mixing tube can have a substantially constant internal diameter within each section.

The application device further comprises a plurality of injection units, which are each configured to inject a corresponding one of the plurality of components into the mixing chamber. The plurality of injection units can be arranged on the mixing tube. The plurality of injection units can be arranged on a wall of the mixing tube, in particular on an outer side of the wall.

The application device further comprises a mixer arranged at least partially in the mixing chamber. The mixer can be arranged completely in the mixing chamber. Preferably, a central piece and mixing elements of the mixer are arranged in the mixing chamber. The mixer is configured to mix the injected components with one another. The mixer can be configured to mix the injected components with one another in the mixing chamber or in the mixing tube, preferably along the mixing tube starting from the first end towards the second end.

According to a second aspect of the disclosure, an application system for mixing a plurality of components for producing a multicomponent mixture and for introducing and/or applying the multicomponent mixture into and/or onto an object is provided. The application system comprises an application device of aspects and embodiments of the disclosure.

Furthermore, the application system can comprise at least one first device for material treatment, which is configured to provide a material flow of the first component, and/or at least one second device for material treatment, which is configured to provide a material flow of the third component.

Furthermore, the application system can comprise at least one first metering device, which is configured to receive the material flow of the first component, to set a mass flow and/or volume flow of this component, and to provide the material flow to the at least one first injection unit of the application device.

Furthermore, the application system can comprise a second metering device, which is configured to receive a material flow of the second component, to set a mass flow and/or a volume flow of the second component, and to provide the material flow to the at least one second injection unit of the application device. According to preferred embodiments, the second component is a gas or a gas mixture, preferably air, and the material flow of the second component is a flow of the gas or gas mixture, preferably an air flow.

Furthermore, the application system can comprise at least one third metering device, which is configured to receive the material flow of the third component, to set a mass flow and/or volume flow of this component, and to provide the material flow to the at least one third injection unit of the application device.

The application device or the application system of an aspect or an embodiment of the disclosure can be configured to carry out methods of an aspect or an embodiment of the disclosure.

Methods of an aspect or an embodiment of the disclosure can be carried out by means of an application device or an application system of an aspect or an embodiment of the disclosure.

According to a further aspect of the disclosure, the use of an application device or an application system of embodiments of the disclosure in a method of embodiments of the disclosure is specified.

According to yet a further aspect of the disclosure, a method of embodiments of the disclosure using an application device or an application system of embodiments of the disclosure is specified.

The aspects of the disclosure can comprise one or more of the following features.

The plurality of sections can comprise a first section and a second section. The first section can be arranged at or adjacent to the first end. The second section can be arranged along the central axis between the first section and the second end. The wall in the first section can have a larger internal diameter than in the second section, or vice versa. The first section can be arranged closer to the first end of the mixing tube than the second section. The first section can be arranged above the second section with respect to a vertical direction. The first section can also be referred to as an upper material chamber.

The plurality of sections can comprise a third section. The third section can be arranged along the central axis between the second section and the second end. The wall of the mixing tube in the third section can have a different internal diameter than in the second section and/or in the first section. The third section can be arranged closer to the second end of the mixing tube than the second section. The wall in the third section can have a smaller internal diameter than in the first section and/or in the second section. The wall in the third section can have a larger internal diameter than in the first section and/or in the second section.

The mixing tube can further comprise a further transition section in each case between two of the plurality of sections. The wall in each of the transition sections can have a variable, preferably a linearly variable, internal diameter along the central axis.

The application device can comprise at least one pressure sensor. Preferably, at least one pressure sensor is provided for at least one of the plurality of sections of the mixing tube, which pressure sensor is configured to measure a pressure in the region of the mixing chamber adjacent to the respective section.

The application device can comprise a first pressure sensor configured to measure a pressure in the region of the mixing chamber adjacent to the first end of the mixing tube and/or adjacent to the first section of the mixing tube. The application device can comprise a second pressure sensor configured to measure a pressure in the region of the mixing chamber adjacent to the second section of the mixing tube. The application device can comprise a third pressure sensor configured to measure a pressure in the region of the mixing chamber adjacent to the second end of the mixing tube and/or adjacent to the third section.

The mixing tube can be substantially straight. This can mean that a center line of the mixing tube or of the mixing chamber is straight. The mixing tube can be substantially vertically oriented. The first end can be arranged above the second end. A length of the mixing tube can be greater than the internal diameter of the wall of the mixing tube. An inner side of the wall of the mixing tube can be rotationally symmetrical about the central axis.

The application device can further comprise a displacement device. The displacement device can be formed as or comprise a lifting cylinder, in particular an electric lifting cylinder or an electro-hydraulic lifting cylinder. The displacement device can be configured to displace the mixer along a central axis of the mixing tube and/or between the first end and the second end. The central axis can also be referred to as a longitudinal axis.

The displacement can take place in such a way that the mixing tube is sealed with respect to a material flow of the injected components and/or of the multi-component mixture from the second end of the mixing tube and/or towards the second end.

The application device can further comprise a rotation device, preferably an electric motor, particularly preferably a servo electric motor. The rotation device can be configured to rotate the mixer, preferably about an axis of rotation which is substantially parallel to the central axis of the mixing tube. The central axis of the mixing tube and the axis of rotation of the mixer can substantially coincide or overlap. The displacement of the mixer can take place along the axis of rotation of the mixer.

The mixer can have a plurality of sections along the axis of rotation and/or along the central axis of the mixing tube, wherein at least two of the plurality of sections have mutually different external diameters.

The mixer can comprise a first section and a second section. The first section can have a larger external diameter than the second section, or vice versa. The first section can be arranged closer to the first end than the second section with respect to the central axis of the mixing tube. The first section can be arranged above the second section in a vertical direction.

The mixer can comprise a third section which is arranged closer to the second end of the mixing tube than the first section and/or second section of the mixer with respect to the central axis of the mixing tube. The third section can have a different external diameter than the first section and/or the second section. The third section can have a larger external diameter than the first section and/or the second section. The third section can have a smaller external diameter than the first section and/or the second section.

The mixer can have a respective section for each of the sections of the mixing tube, wherein each section of the mixing tube overlaps with the respective section of the mixer in a plane perpendicular to the central axis of the mixing tube. The plane can comprise a radial direction of the mixing tube.

The application device can comprise at least one mixing element. The mixing element can be arranged on the wall, in particular on an inner side of the wall of the mixing tube, and extend into the mixing chamber. The mixing element can extend towards the central axis of the mixing tube. The mixing element can be formed as a ring. The mixing element can be formed as a lamella, tine, hook or rod, or wherein the at least one mixing element is formed as a regular or irregular structure.

The plurality of injection units of the application device can comprise at least one first injection unit and/or at least one second injection unit and/or at least one third injection unit.

The at least one first injection unit can be arranged on the wall of the mixing tube in the first section of the mixing tube. The at least one first injection unit can be configured to inject a first component into a region of the mixing chamber which is adjacent to the first section of the mixing tube.

The at least one second injection unit can be arranged on the wall of the mixing tube in the second section of the mixing tube. The at least one second injection unit can be configured to inject a second component into a region of the mixing chamber which is adjacent to the second section of the mixing tube.

The at least one third injection unit can be arranged on the wall of the mixing tube in the third section of the mixing tube. The at least one third injection unit can be configured to inject a third component into a region of the mixing chamber which is adjacent to the third section of the mixing tube.

The internal diameter of the mixing tube can be greater than the external diameter of the mixer along the central axis of the mixing tube between the first end and the second end. The internal diameter of the mixing tube can be defined as an internal diameter of the wall of the mixing tube, wherein any mixing elements of the mixing tube are not taken into account. The extent of the mixer in a plane which comprises the radial direction of the mixing tube can be defined as an external diameter of the mixer, wherein any mixing elements of the mixer are taken into account for the extent of the mixer.

The mixer can be displaced along the mixing tube between a first position and a second position. The second position can be closer to the second end than the first position along the mixing tube, in particular along the central axis. On the other hand, the first position can be closer to the first end than the second position along the mixing tube. The mixer can be displaced from the first position in the direction of the second end into the second position.

Alternatively or additionally, the mixer can be displaced from the second position in the direction of the first end into the first position. This displacement can likewise have the effect that the mixing tube is sealed with respect to a material flow of the injected components and/or of the multi-component mixture from the second end and/or towards the second end.

The mixing tube can comprise at least one sealing element. The mixing tube can comprise a plurality of sealing elements. The sealing element can be arranged on or in the region of the second end of the mixing tube, or the sealing element can be formed by the second end of the mixing tube.

The sealing element can be formed as a ring or substantially annularly. A displacement of the mixer towards the second end or a displacement away from the second end can have the effect that the mixer, in particular a mixing element of the mixer, comes into contact with the sealing element and the mixing tube is thereby sealed.

The sealing element can also be formed as a cone or substantially conically. This can mean that a surface of the sealing element directed in the direction of the central axis of the mixing tube is conical. In particular, the sealing element can be formed as a conical seat for an end of the mixer.

The mixer can have a conical, frustoconical, conical, needle-shaped or pointed end which lies opposite the second end of the mixing tube. A displacement of the mixer towards the second end can have the effect that the end of the mixer comes into contact with the sealing element and the mixing tube is thereby sealed.

The sealing element and the first end of the mixer can form a needle valve.

The mixer can be displaced in such a way that the end of the mixer and the sealing element of the mixing tube overlap in a plane perpendicular to the central axis of the mixing tube and/or that the first end of the mixer and the sealing element of the mixing tube are in contact.

A central axis of the mixer can extend substantially along the mixing tube, in particular along the central axis. The mixer can be substantially rod-shaped or have a rod. The mixer can have a central piece which is substantially rotationally symmetrical and/or is substantially rod-shaped or is a rod. The central piece can extend substantially along the central axis of the mixing tube. An axis of symmetry or central axis of the central piece can substantially coincide with the central axis of the mixing tube.

The mixer can comprise at least one mixing element. The mixing element serves for efficient mixing of the injected components by the mixer. The mixing element can extend in the radial direction of the mixer. The mixing element can be arranged on an outer side of the central piece and/or a lateral surface of the central piece, and/or extend in a radial direction of the central piece. According to preferred embodiments, the mixer comprises a plurality of mixing elements. The plurality of mixing elements can be arranged distributed along the central piece and/or with respect to the central axis. In addition, the plurality of mixing elements can be arranged distributed in the circumferential direction of the central piece. Particularly preferably, the mixing elements are formed and/or arranged in such a way that no imbalance forms when the mixer is rotated about the axis of rotation. The axis of rotation of the mixer can coincide with the axis of symmetry.

The at least one mixing element can be formed as a lamella, tine, hook or rod. The at least one mixing element can be formed as a ring surrounding the central piece. The at least one mixing element can be formed as or comprise a thread or a helix.

According to embodiments, the application device comprises a plurality of first injection units, and/or a plurality of second injection units and/or a plurality of third injection units. Correspondingly, the application system can comprise a plurality of first metering devices, a plurality of first devices for material treatment, a plurality of second metering devices, a plurality of second devices for material treatment and a plurality of third metering devices.

The injection units can be configured to receive the material flow of the corresponding component from the corresponding metering devices.

A mixing section can be defined by the mixing chamber starting from the first end towards the second end. The plurality of injection units can each be configured to inject the corresponding one of the plurality of components into the mixing chamber at a corresponding position along the mixing section.

The first injection unit can be configured to inject the first component at a first position along the mixing section. The second injection unit can be configured to inject the second component at a second position, which is arranged along the mixing section at or behind the first position. The second component can be or comprise a gas or a gas mixture, preferably air. The third injection unit can be configured to inject the third component at a third position. The third position can be arranged along the mixing section at or behind the second position.

The mixer can be configured to mix the injected components with one another on the basis of the sequence in which they have been or are injected at the corresponding positions along or with respect to the mixing section, or along the mixing chamber. Therefore, the injected components can be mixed with one another on the basis of this sequence. By mixing the injected components, the multicomponent mixture can be produced. Subsequently, the multicomponent mixture can be discharged from the mixing tube and the application device via the second end of the mixing tube, and the multicomponent mixture can be applied to an object.

The closed first end can be sealed with respect to the components injected into the mixing chamber. The open second end serves to discharge the produced multicomponent mixture from the mixing tube. The mixing section can be defined as a course of the central axis of the mixing tube starting from the first end towards the second end. The respective position along the mixing section can be defined as a projection of the respective injection point onto the center line of the tube.

The injection units can also be referred to as injection units. The injection units can each comprise a nozzle, which is configured to inject the corresponding component into the mixing chamber.

The mixer can be configured to mix the first component and the second component with one another first along the mixing section. The mixer can be configured to next mix the mixture of the first component and the second component with the third component with one another. Correspondingly, a method of embodiments and aspects of the disclosure can further comprise mixing, by means of the mixer, the mixture of the first component and the second component with the third component for producing the multicomponent mixture comprising the third component.

The mixing of the components can take place by rotating the mixer. The mixer can be rotated about an axis of rotation. The axis of rotation can be substantially parallel to the central axis or a central line of the mixing tube.

The injection units can comprise at least one fourth injection unit for injecting a fourth component at a fourth position, which is arranged along the mixing section in front of the third position, in particular between the second position and the third position.

The injection units can comprise at least one fifth injection unit for injecting a fifth component at a fifth position, which is arranged along the mixing section in front of the third position, in particular between the second position and the third position, in particular behind the fourth position.

The mixer can be configured to first mix the first component and the second component along the mixing section, next to mix the mixture of the first component and the second component with the fourth component or with the fifth component, or next to mix the mixture of the first component and the second component with the fourth component and then the mixture of the first component, the second component and the fourth component with the fifth component. The mixer can be configured to mix the mixture of the first component, the second component, the fourth component and/or the fifth component with the third component.

Each of the injection units can be arranged on the mixing tube, in particular on a wall of the mixing tube. For example, the injection units are arranged on an outer side of the wall of the mixing tube.

The mixing tube can comprise a plurality of injection points for injecting a corresponding one of the components. An injection point can be formed as a hole or bore through the wall of the mixing tube. Each of the injection units can be arranged on a corresponding one of the injection units. Each of the injection units can be configured to be attached to a corresponding one of the injection points. Each of the injection points can correspond to a specific position along the mixing section defined by the mixing chamber.

At least one of the plurality of injection units can be formed removably from the mixing tube, in particular from the wall of the mixing tube, and/or formed displaceably along the mixing tube. As a result, the injection unit can be arranged at different injection points on the mixing tube. The corresponding component can thus be injected into the mixing chamber at at least two different positions along the mixing section. As a result, the sequence of the injection and of the mixing of the components can be made even more flexible.

The plurality of injection units can comprise a plurality of first injection units, for example two or three. The plurality of first injection units can each be configured to inject a corresponding one of a plurality of first components at a corresponding one of a plurality of first positions along the mixing section. The plurality of injection units can comprise a plurality of second injection units, for example two or three. The plurality of second injection units can each be configured to inject a corresponding one of a plurality of second components at a corresponding one of a plurality of second positions along the mixing section. In particular, each of the second positions can be arranged along the mixing section behind each of the first positions. The plurality of injection units can comprise a plurality of third injection units, for example two or three. The plurality of third injection units can each be configured to inject a corresponding one of a plurality of third components at a corresponding one of a plurality of third positions along the mixing section. In particular, each of the third positions can be arranged along the mixing section behind each of the second positions. The same can apply to the fourth and fifth injection units for injection. Each of the at least one first to fifth components can also be injected multiple times.

Alternatively or additionally, the plurality of injection units can comprise a plurality of first injection units, wherein each of the plurality of first injection units is configured to inject the first component at a corresponding one of a plurality of first positions. The plurality of injection units can comprise a plurality of third injection units, wherein each of the plurality of third injection units is configured to inject the third component at a corresponding one of a plurality of third positions. The same can apply to the second component, the fourth component and/or the fifth component. On the one hand, the respective component can thereby be injected multiple times. On the other hand, it can thereby be varied at which position or with which injection unit the first, second, third, fourth or fifth component are injected into the mixing chamber. This is advantageous when one injection unit has to be serviced. Then, a different injection unit can be dispensed with for the same component.

At least one of the first, third, fourth and fifth components can be or comprise a fluid, and/or can be liquid (at 20° C. and 1 bar). In particular, the first component and/or the third component can be liquid. The components can have a dynamic viscosity, in particular determined according to DIN EN ISO 2884 at 20° C., between 0.5 mPa s and 100,000 mPa s.

Each of the at least first, third, fourth and fifth components can be one of the following or comprise at least one of the following: water, a starter, an inhibitor, an accelerator, a booster, a monomer, a monomer for the polymerization of polyurethane, a polyol, a diol, polyisocyanate, isocyanate, diisocyanate, moist air. Preferably, each of the components comprises at most one monomer for the polymerization of polyurethane. The at least second component can be one of the following or comprise at least one of the following: a technical gas, N2, CO2, NO, a mixture of at least two of the gases mentioned.

By mixing the plurality of components, the multicomponent mixture can be produced. In particular, by mixing the gas or the gas mixture with at least one other component, a foam can be produced. This can also be referred to as foaming, in particular as physical foaming. In particular, by mixing the first component and/or the third component with the gas or the gas mixture, a foam can be produced.

The first component can comprise a first monomer for the polymerization of polyurethane. The third component can comprise a second monomer for the polymerization of polyurethane. Polyurethane can be polymerized by a chemical reaction of the first monomer with the second monomer. The polymerization can take place in the mixing space and/or outside the mixing space, after discharging the polyurethane from the mixing space. The polyurethane can be foamed, in particular physically foamed, by the gas or the gas mixture.

The first component can be or comprise a polyol, in particular diol, and/or the third component can be or comprise a polyisocyanate, in particular diisocyanate. Alternatively, the first component can be or comprise a polyisocyanate, and/or the third component can be or comprise a polyol. The fourth component can in particular be or comprise an accelerator or booster for the third component and/or the first component. The fifth component can in particular be or comprise water. The injection of water can be used for rinsing the mixer and/or the mixing tube.

The application device can comprise a rinse injection unit. The rinse injection unit can be configured to inject a rinse medium into the mixing chamber for rinsing the mixing chamber. The rinse medium can be or comprise a fluid, in particular water. The rinse injection unit can, with respect to the first to fifth injection units, inject the rinse medium into the mixing chamber at an arbitrary position along the mixing section. Additionally or alternatively, one of the first to fifth injection units can be used for injecting a rinse medium.

The produced multicomponent mixture can emerge independently from the mixing tube and the application device at the second end. This can take place in particular in that the mixing tube is arranged vertically. The material of the multicomponent mixture then already emerges as a result of gravity. Because the first end of the mixing tube is closed and the components are injected into the mixing space, the material of the multicomponent mixture is furthermore pressed out of the mixing tube by the material of the injected components flowing in. Alternatively or additionally, the mixer can be formed in such a way that rotation of the mixer presses the material of the multicomponent mixture out of the mixing tube.

The produced multicomponent mixture can be a foam, in particular a PU foam. The emerged multicomponent mixture can be applied to an object or introduced into the object. In particular, a PU foam can be applied to or introduced into a lithium-ion battery.

The object can be a lithium-based battery or battery cell, or a lithium-ion battery or battery cell. The multicomponent mixture can be or comprise a polyurethane foam.

Each of the metering devices can also be configured to set a volume flow of the corresponding components. The first metering device can be configured to measure a mass flow and/or a volume flow of the first component. The third metering device can be configured to measure a mass flow and/or a volume flow of the third component. Between a volume or a volume flow and a mass or a mass flow of the respective component, it is possible to convert in a simple manner on the basis of pressure, temperature and/or molar volume.

According to preferred embodiments, the application system comprises at least two first devices for material treatment for the first component and/or at least two second devices for material treatment for the third component. Here, each of the first devices can provide a material flow to the first metering device. The first metering device can be configured to receive a material flow from one of the two first metering devices, or to receive a material flow from the two first devices for material treatment at the same time. The same applies correspondingly to the second devices for material treatment and the third metering device for the third component. By providing two devices for material treatment per component, it can be ensured that the respective metering device continuously receives a material flow. As a result, a continuous operation of the application system can be ensured.

The first component and/or the third component can be injected into the mixing space in an air-free state and/or in a gas-free state.

The mixer can be configured to mix the injected components with one another on the basis of the sequence in which they are injected at the corresponding positions along the mixing section.

The first pressure sensor can be configured to measure a pressure in the mixing chamber at a position along the mixing section in the region of the first position or between the first position and the second position. The second pressure sensor can be configured to measure a pressure in the mixing chamber at a position along the mixing section in the region of the second position or between the second position and the third position. The third pressure sensor can be configured to measure a pressure in the mixing chamber in the region of the third position or at a position along the mixing section after the third position and/or between the third position and the second end.

The application system can be configured to mix the first component and/or the third component with the gas or the gas mixture in the mixing space of the application device, in particular exclusively in the mixing space.

The application system can be configured to mix the first component with the gas or gas mixture in a or with respect to a material flow direction of the first component not upstream of the first metering device or upstream of the application device. The application system can be configured to mix the third component with the gas or gas mixture in a or with respect to a material flow direction of the third component not upstream of the third metering device or upstream of the application device.

The second metering device can comprise a measuring unit and an actuator. The measuring unit can be a gas mass sensor or gas quantity sensor. The actuator can be a controlled or regulated gas valve, in particular a proportional gas valve. The measuring unit can be configured to receive a flow of the gas or gas mixture from a gas supply device of the application system, to measure a mass flow and/or a volume flow, and to provide the flow to the actuator. The actuator can be configured to receive the flow, to set the mass flow and/or the volume flow of the flow of the gas or gas mixture, and to provide the flow to the second injection unit. The actuator can alternatively or additionally be configured to set a pressure in a line which conducts the flow of the gas or gas mixture, preferably the second line. Alternatively or additionally, the measuring unit can be configured to set an amount and/or a volume flow and/or a mass flow of the flow of the gas or gas mixture. For air, the measuring unit can be an air mass sensor or an air quantity sensor, the gas valve can be an air valve, and the gas supply device can be an air supply device, be configured as an air pump or comprise an air pump. A quantity sensor can also be referred to as a flow meter.

The application system can furthermore comprise a first line, preferably a channel, a hose or a tube, between the gas supply device and the second metering device. The application system can comprise a second line, preferably a channel, a hose or a tube, between the second metering device and the application device, for conducting the flow of the gas or gas mixture. A line can also be referred to as a fluid conducting element.

The application system can furthermore comprise a first line pressure sensor which is configured to measure a pressure, in particular a gas pressure or an air pressure, in the first line. The application system can comprise a second line pressure sensor configured to measure a pressure, in particular a gas pressure or an air pressure, in the second line.

The application system can furthermore comprise a control unit. The control unit can comprise a computing unit, for example a microprocessor. A method of embodiments and aspects of the disclosure can comprise a control step. The control unit can be configured to carry out the control step. The control can be carried out using the control unit.

The control can comprise actuating the rotation device for the mixer and/or the first metering device and/or the second metering device and/or the third metering device and/or the gas supply device. The control unit can be configured to correspondingly actuate the rotation device, the first metering device, the second metering device, the third metering device and/or the gas supply device.

The actuation of the rotation device can serve to set the rotational speed of the mixer. The actuation of the first metering device can serve to set the mass flow and/or the volume flow of the first component. The actuation of the second metering device can serve to set the mass flow and/or the volume flow of the second component. The actuation of the second metering device can comprise actuating the actuator and/or the measuring unit, which can serve to set the mass flow and/or the volume flow of the second component and/or a pressure in a line which conducts the gas or gas mixture. The actuation of the third metering device serves to set the mass flow and/or volume flow of the third component. The actuation of the gas supply device can serve to set a pressure of the flow of the gas or gas mixture and/or a pressure in a line which conducts the gas or gas mixture, for example the first or second line.

The control can be carried out on the basis of a setpoint value for a ratio between a mass flow of the second component and the mass flow of the first component, and/or a setpoint value for a ratio between the mass flow of the second component and the mass flow of the third component, and/or a ratio between a mass flow of the first component and the mass flow of the third component, in particular a ratio of the respective mass flows which are injected into the mixing chamber. Alternatively or additionally, the control can also be carried out on the basis of a ratio between the corresponding volume flows.

Alternatively or additionally, the control can be carried out on the basis of a value for the mass flow of the second component and/or a value for the mass flow of the first component and/or a value for the mass flow of the third component and/or a value for the rotational speed of the mixer and/or a value for a pressure in the mixing chamber and/or a value for the pressure in the first line and/or a value for the pressure in the first or second line. The specified values can be set values or measured values of the corresponding specified variables. Alternatively or additionally, the control can also be carried out on the basis of the values for the corresponding volume flows.

The control can comprise controlling a mixing ratio of the plurality of components in the multicomponent mixture. The control can comprise controlling a ratio between the mass and/or the volume of the second component and a mass and/or the volume of at least one of the other components in the multicomponent mixture. The control can comprise controlling a ratio between the mass flow and/or volume flow of the second component and a mass flow and/or volume flow of at least one of the other components. The control can comprise controlling a ratio between the mass and/or the volume of the second component and a mass and/or the volume of at least one of the other components in the multicomponent mixture. This can also apply correspondingly to each of the other components. The mass flows or volume flows can be the flows of the material flows of the components which are injected into the mixing chamber.

The control can comprise controlling the ratio between the mass flow of the second component and the mass flow of the first component and/or controlling the ratio between a mass flow of the second component and the mass flow of the third component, and/or the ratio between a mass flow of the first component and the mass flow of the third component. Alternatively or additionally, the control can also be carried out by controlling the ratio between the corresponding volume flows of the components. The control can be carried out in particular by actuating the second metering device and/or by actuating the first metering device and/or by actuating the third metering device and/or by actuating the gas supply device and/or by actuating the rotation device. A setpoint value for the ratio can be predefined by the control unit or by an external system or a user of the application device. The setpoint value can be predefined by a mathematical function.

The control can comprise controlling a mass flow and/or volume flow of the second component, in particular in such a way that it is proportional to the mass flow and/or volume flow of the first component and/or to the mass flow and/or volume flow of the third component and/or proportional to the rotational speed of the mixer. The control can be carried out in particular by actuating the second metering device and/or by actuating the first metering device and/or by actuating the third metering device and/or by actuating the gas supply device and/or by actuating the rotation device.

The control can comprise controlling a pressure of the second component, in particular in a line for conducting the material flow of the second component, for example the first line or the second line, and/or at the second injection point for the second component, in such a way that this pressure is greater, preferably by 1 bar greater, than a pressure in the mixing chamber, preferably at a position in the region of the first position along the mixing section. The control can be carried out in particular by actuating the gas supply device and/or the second metering device.

The control can comprise controlling a pressure of the second component, in particular in a line for conducting the material flow of the second component and/or at the second injection point for the second component, in such a way that the second component is injected into the mixing chamber at a greater pressure than the first component and/or than the third component. Preferably, the difference can be 1 bar or more.

The control can comprise controlling a rotational speed of the mixer, in particular in such a way that the rotational speed is proportional to the mass flow and/or volume of the first component and/or proportional to the mass flow and/or volume flow of the third component. The control can be carried out in particular by actuating the rotation device.

The first component and/or the third component can be injected into the mixing space in an air-free and/or gas-free state. The first component can pass the first metering device in an air-free or gas-free state. The third component can pass the third metering device in an air-free or gas-free state. The application system can be configured in such a way that the first component and/or the third component are injected in an air-free or gas-free state and/or pass the corresponding metering device.

The first metering device can be configured to receive the material flow of the first component from the first device for material treatment. The third metering device can be configured to receive the material flow of the third component from the second device for material treatment.

The devices for material treatment (also referred to as material treatment device for short below), in particular the first device for material treatment and/or the third device for material treatment, can comprise a material container and a pump device. The material container can be configured to treat the corresponding component. The pump device can have an inlet and an outlet. The inlet of the pump device can be connected in a fluid-communicating manner to the material container, such that the component can be introduced from the material container into the pump device. The pump device can be configured to provide the component at the outlet of the pump device at a pressure of at least 15 bar.

According to a further aspect of the disclosure, a method for material treatment is specified. The method can comprise the steps of: treating a component, in particular a first component or a third component, in a material container; introducing the component from the material container into an inlet of a pump device; increasing the pressure of the component by means of the pump device; and discharging the component from an outlet of the pump device. The component can have a pressure of at least 15 bar at the outlet of the pump device.

Any material treatment device disclosed herein can be used in the method for material treatment.

Furthermore disclosed is a use of a material treatment device disclosed herein for the treatment of a component for the polymerization of polyurethane. The component can be a monomer for the polymerization of polyurethane.

The application device, in particular the first injection unit, can be connected in a fluid-communicating manner to the outlet of the first device for material treatment. The application device, in particular the third injection unit, can be connected in a fluid-communicating manner to the outlet of the second device for material treatment. As a result, the first component and the third component can be introduced into the application device, in particular the mixing chamber. The application device can be configured to mix the first component and the third component to form a mixture or a multicomponent mixture and to apply said mixture to an object, in particular to a battery or an accumulator.

Pressure values disclosed herein are absolute pressure values. The pressure values are therefore based on an absolute vacuum. The ambient pressure is approximately 1 bar.

As a result of the treatment of the respective component, a constant state of the component can be achieved before said component is provided with a relatively high pressure for further processing, as a result of which a high metering accuracy with a high volume flow is achieved. For example, components, such as components comprising monomers for the polyurethane polymerization, are often provided in barrels. If the components are stirred in order to ensure a homogeneous distribution of substances in the component, air is introduced into the component. The amount of air introduced can vary, such that an accurate metering of the component is made more difficult.

At the inlet of the pump device, the component can have a pressure of less than 1.0 bar. Preferably, the component has a pressure of less than 0.9 bar, more preferably less than 0.8 bar, more preferably less than 0.7 bar, more preferably less than 0.6 bar, at the inlet of the pump device. The component can have a pressure at the inlet of the pump device which is lower than the ambient air pressure. A vacuum can prevail at the inlet of the pump device.

The pump device can comprise or be a high-pressure pump. The pump device can comprise or be a piston pump. Preferably, the pump device comprises or is a high-pressure piston pump.

The pump device can comprise no diaphragm pump. In other words, a diaphragm pump cannot be contained in the pump device.

The pump device can be configured to provide the component at the outlet of the pump device at a pressure of at least 60 bar. Preferably, the pump device is configured to provide the component at the outlet of the pump device at a pressure of at least 60 bar, more preferably of at least 100 bar, more preferably of at least 200 bar, more preferably of at least 300 bar.

The pump device can be configured to provide the component at the outlet of the pump device at a pressure between 15 bar and 350 bar, in particular between 20 bar and 350 bar.

The pump device can be configured to increase the pressure of the material from the inlet to the outlet by at least 15 bar, preferably by at least 60 bar, more preferably by at least 100 bar, more preferably by at least 200 bar, more preferably by at least 300 bar.

The pump device can be configured to control or regulate or set a volume flow or mass flow of the component at the outlet of the pump device.

The pump device can comprise a drive. The drive can be a hydraulic drive, in particular a servo-hydraulic drive.

The material container can comprise at least one treatment unit. The treatment unit can be configured to treat a corresponding component in the material container. In particular, the treatment unit is configured to heat, degas, place under vacuum, stir and/or mix the component in the material container.

The material container can be heatable. Preferably, the material container comprises at least one heating element. The heating element can be an electric heating element. The heating element can be configured to heat the temperature of the corresponding component in the material container to a temperature of at least 30° C., preferably of at least 40° C., more preferably of at least 50° C., more preferably of at least 60° C., more preferably of at least 70° C., more preferably of at least 80° C., more preferably of at least 100° C.

A vacuum can be present in the material container. The pressure in the material container can be lower than the ambient air pressure. The pressure in the material container can be less than 1.0 bar, preferably less than 0.8 bar, more preferably less than 0.6 bar, more preferably less than 0.5 bar, more preferably less than 0.4 bar.

The material container can comprise a vacuum unit. The vacuum unit can be configured to provide a vacuum in the material container. The vacuum unit cannot be part of the material container and in particular be connected to the material container.

The material container can be configured to stir the component in the material container. Preferably, the material container comprises an agitator, more preferably a movable agitator. The agitator can be drivable by a drive.

The component can comprise a monomer for the polymerization of polyurethane. The component can be mixed downstream of the pump device with a further monomer for the polymerization of polyurethane. Polyurethane can be polymerized by a chemical reaction of the monomers.

Preferably, the component comprises at most one monomer for the polymerization of polyurethane. The component can comprise a polyol. In particular, the component comprises a diol. The component can comprise a polyisocyanate. In particular, the component comprises a diisocyanate. The component can be liquid (at 20° C. and 1 bar).

The component can have a dynamic viscosity, in particular determined according to DIN EN ISO 2884 at 20° C., between 0.5 mPa s and 100,000 mPa s.

Generally, the first component can comprise a first monomer for the polymerization of polyurethane. The third component can comprise a second monomer for the polymerization of polyurethane. Polyurethane can be polymerized by a chemical reaction of the first monomer with the second monomer. The polyurethane can be foamed, in particular physically foamed, by gas.

According to a further aspect of the disclosure, an application device for mixing a plurality of components for producing a multicomponent mixture and for introducing and/or applying the multicomponent mixture into and/or onto an object is specified.

The application device comprises a mixing tube with a first closed end and a second end for discharging the multicomponent mixture from the mixing tube, wherein the mixing tube comprises a mixing chamber. The mixing chamber can be arranged between the first end and the second end.

The application device comprises a plurality of injection units, which are each configured to inject a corresponding one of the plurality of components into the mixing chamber. The injection units can comprise at least one first injection unit for injecting a first component, at least one second injection unit for injecting a second component, in particular a gas or gas mixture, preferably air, and at least one third injection unit for injecting a third component. The plurality of injection units can be arranged on the mixer.

The application device further comprises a mixer arranged at least partially in the mixing chamber, which mixer is configured to mix the injected components with one another. The mixer can be configured in particular to mix the injected components with one another in the mixing chamber, preferably along the mixing chamber and/or along the mixing tube. The mixer can be arranged completely in the mixing chamber.

According to a further aspect of the disclosure, a method for mixing a plurality of components for producing a multicomponent mixture is specified. The method comprises the steps of: injecting a first component by means of a first injection unit of an application device into a mixing chamber in a mixing tube of the application device, injecting a second component, in particular a gas or gas mixture, preferably air, by means of a second injection unit of the application device into the mixing chamber, mixing the first component with the second component by means of a mixer arranged in the mixing chamber for producing the multicomponent mixture.

The method can further comprise injecting a third component by means of a third injection unit of the application device into the mixing chamber and mixing the mixture of the first component with the second component with the third component for producing the multicomponent mixture comprising the third component. The method can further comprise discharging the multicomponent mixture from the mixing tube, in particular a second open end of the mixer. The method can further comprise applying the multicomponent mixture onto the object or introducing the multicomponent mixture into the object. The mixing can comprise rotating the mixer.

The injection of the first component can take place at a first position along a mixing section defined by the mixing chamber, the injection of the second component can take place at a second position which is at or behind the first position along the mixing section, and the injection of the third component can take place at a third position which is at or behind the second position along the mixing section.

The method can further comprise at least one of the following steps of: setting a mass flow and/or volume flow of a material flow of the first component and providing the material flow to the at least one first injection unit of an application device, setting a mass flow and/or volume flow of a material flow of the second component and providing the material flow of the second component to the at least one second injection unit of the application device, setting a mass flow and/or volume flow of a material flow of the third component and providing the material flow to the at least one third injection unit of the application device.

According to a further aspect, an application system comprising an application device of aspects and embodiments of the disclosure is specified. The application system can comprise at least one device for material treatment of aspects and embodiments of the disclosure.

### BRIEF DESCRIPTION OF THE DRAWINGS

The aspects of the disclosure are explained below on the basis of drawings. In the drawings:

FIG. 1A shows a schematic cross-sectional view of an application device of embodiments of the disclosure;

FIG. 1B shows a schematic cross-sectional view of an application device of further embodiments of the disclosure;

FIG. 2 shows a schematic cross-sectional view of a part of an application device of still further embodiments of the disclosure;

FIGS. 3A, 3B show schematic cross-sectional views of the second end of a mixing tube and a mixer in different positions of an application device of embodiments of the disclosure;

FIGS. 4A, 4B show schematic cross-sectional views of the second end of a mixing tube and a mixer in different positions of an application device of further embodiments of the disclosure;

FIGS. 5A, 5B show schematic cross-sectional views of the second end of a mixing tube and a mixer in different positions of an application device of still further embodiments of the disclosure;

FIG. 6 shows a schematic view of a mixing section of embodiments of the disclosure;

FIG. 7 shows a device for material treatment of embodiments of the disclosure;

FIG. 8 shows an enlarged illustration of a material container of a device for material treatment of embodiments of the disclosure;

FIG. 9 shows schematic view of an application system of embodiments of the disclosure;

FIG. 10 shows a flow diagram of a method of embodiments of the disclosure;

FIG. 11 shows a flow diagram of a method of further embodiments of the disclosure; and

FIG. 12 shows a diagram for illustrating a control step of a method for mixing a plurality of components for producing a multicomponent mixture and for introducing/applying the multicomponent mixture into/onto an object of embodiments of the disclosure.

### DETAILED DESCRIPTION OF THE EMBODIMENTS

In the following, the same reference signs denote identical or corresponding elements.

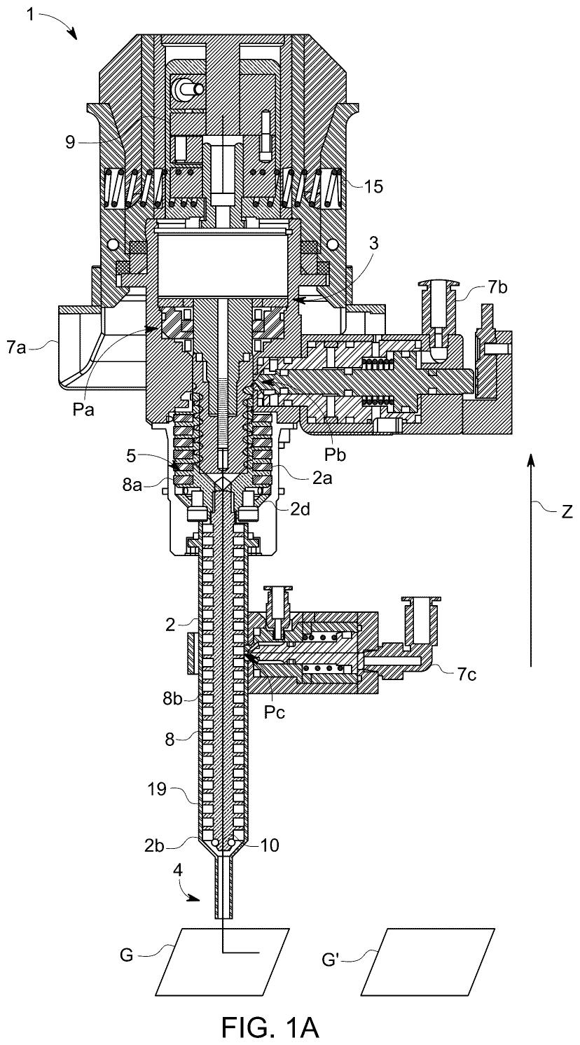

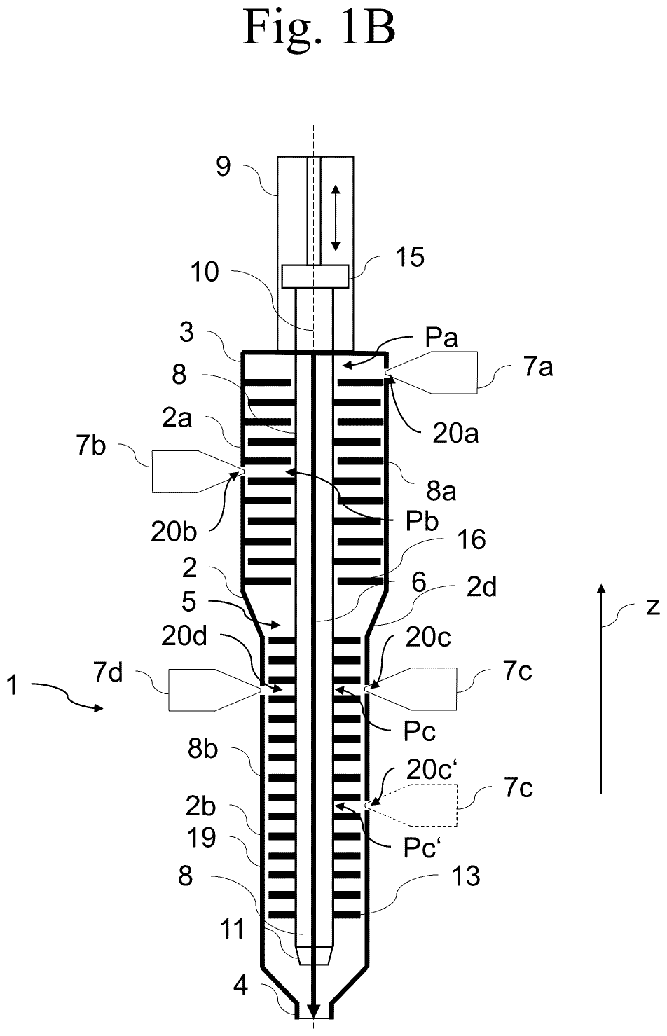

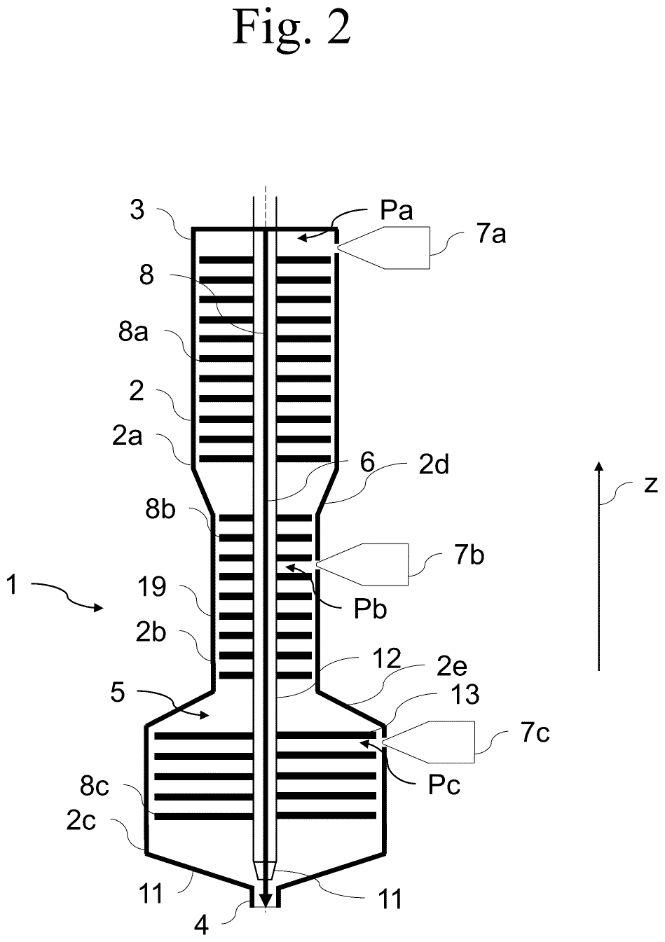

FIG. 1A shows a schematic cross-sectional view of an application device of embodiments of the disclosure. FIG. 1B shows a schematic cross-sectional view of an application device of further embodiments of the disclosure. FIG. 2 shows a schematic cross-sectional view of a part of an application device of still further embodiments of the disclosure.

The application device 1 is configured for mixing a plurality of components for producing a multicomponent mixture and for introducing and/or applying the multicomponent mixture into or onto an object G. The multicomponent mixture is, for example, polyurethane foam.

The PU foam can be applied into or onto the object by means of the application device 1. The object G is, for example, a lithium-ion battery or battery cell. For example, the PU foam can be introduced into an interior space of the battery and/or into an intermediate space between the battery cells of the battery. The PU foam serves, for example, for fire protection.

The application device 1 comprises a mixing tube 2 with a first end 3 and a second end 4. The first end 3 is closed. This means that the end is sealed with respect to components of the multi-component mixture injected into the mixing tube 2. The second end 4 is open and serves to discharge the multicomponent mixture from the mixing tube 2. Between the first end 3 and the second end 4, the mixing tube 2 comprises a mixing chamber 5. The mixing chamber 5 defines a mixing section 6 starting from the first end 3 towards the second end 4. The mixing chamber 5 is arranged in the mixing tube 2. The mixing chamber 5 can also be referred to as a mixing chamber.

The mixing tube 2 is substantially straight. This means that a central line 10 of the mixing tube 2 is straight. The central line 10 can also be referred to as a central axis. The mixing tube 2 has a wall 19. An inner side of the wall 19 can be substantially rotationally symmetrical about the central axis 10, as shown. The inner side of the wall 19 adjoins the mixing chamber 5. The mixing tube 2 is substantially vertically oriented. This means that the central axis 10 extends substantially along a vertical spatial direction z.

As shown, the mixing tube 2 has a plurality of sections 2a, 2b, 2c along the central axis 10. In the embodiments of FIGS. 1A and 1B, the mixing tube has two sections 2a, 2b. In the embodiment of FIG. 2, the mixing tube has three sections 2a, 2b, 2c. However, the disclosure is not restricted thereto. For example, a first section 2a is arranged at or adjacent to the first end 3 and a second section 2b is arranged along the central axis 10 between the first section 2a and the second end 4. A third section 2c can be arranged at or adjacent to the second end 4. The third section 2c is arranged along the central axis 10, for example, between the second section 2c and the second end 4.

The wall 19 of the mixing tube 2 has a substantially constant internal diameter within each section 2a, 2b, 2c. However, the wall 19 of the mixing tube 2 has mutually different internal diameters between the sections 2a, 2b, 2c. Thus, the wall 19 has a different internal diameter in the section 2a than in the section 2b. Moreover, the wall 19 has a different internal diameter in the section 2b than in the section 2c. Furthermore, the wall 19 has a different internal diameter in the section 2a than in the section 2c. When considering the internal diameter, any mixing elements 16, as will be described in detail later, cannot be taken into account.

As shown in FIGS. 1A, 1B, the wall 19 has a larger internal diameter in the first section 2a than in the second section 2b. The first section 2a can also be referred to as an upper material chamber of the mixing tube 2 and the second section 2b can also be referred to as a lower material chamber.

As shown in FIG. 2, the wall 19 has a larger internal diameter in the third section 2a than in the sections 2a, 2b. According to further embodiments, the internal diameter in the third section 2c can also be smaller than in the sections 2a, 2b.

As shown, further transition sections 2d, 2e of the mixing tube 2, in which the wall 19 of the mixing tube 2 has a variable internal diameter, can be arranged between the sections 2a, 2b, 2c. The internal diameter can vary, for example, linearly along the central axis 10. A transition can thereby be created between the different internal diameters of the respective sections 2a, 2b, 2c.

The wall 19 of the mixing tube 2 has injection points 20a, 20b, 20c for corresponding injection units 7a, 7b, 7c, which are described in detail below. As shown, the injection points are arranged on the wall 19 of the mixing tube 2. However, the disclosure is not restricted thereto. The injection points serve merely to provide access for the injection units to the mixing chamber 5 for injecting the components. The injection points can be formed as holes or bores through the wall 19.

The application device 1 further comprises a plurality of injection units 7a, 7b, 7c. These are each configured to inject a corresponding component into the mixing chamber 5. As shown, the injection units 7a, 7b, 7c are arranged on the wall 19 of the mixing tube 2, more precisely on an outer side of the wall 19, but the disclosure is not restricted thereto. Each of the injection units 7a, 7b, 7c is arranged at a corresponding injection point 20, 20b, 20c and is configured to inject the corresponding component into the mixing chamber 5 via the injection point. The injection units 7a, 7b, 7c thus inject the corresponding component at a predetermined position Pa, Pb, Pc for this component along the mixing section 6.

As shown by way of example in FIG. 1A for the injection unit 7b and 7c, each of the injection units 7a, 7b, 7c can comprise a nozzle. Each of the injection units is further configured to stop the injection of the component. For this purpose, each of the injection units 7a, 7b, 7c can comprise a corresponding inlet valve, which is configured for example as a needle valve. The inlet valve 7a, 7b, 7c can be configured as a PWM valve. An injection of the respective component into the mixing chamber 5 can thereby be completely stopped. This is necessary, for example, when sufficient PU foam has been applied to the object G and a change is made to the next object G′. A material flow of the respective component can then be briefly interrupted by means of the inlet valves.

A first injection unit 7a is provided for injecting a first component via a first injection point 20a at a first position Pa along the mixing section 6. A second injection unit 7b is provided for injecting a second component via a second injection point 20b at a second position Pb along the mixing section 6. A third injection unit 7c is provided for injecting a third component via a third injection point 20c at a third position Pc along the mixing section 6. The second position Pb is arranged along the mixing section 6 behind the first position Pa, and the third position Pc is arranged along the mixing section 6 behind the second position Pb.

For cleaning and rinsing the application device 1, in particular the mixing tube 2, the mixer 8 and the mixing chamber 5, only air or the first component is injected into the mixing chamber 5. According to embodiments not shown, the application device 1 can further comprise a rinse injection unit. The rinse injection unit can be configured to inject a rinse medium into the mixing chamber 5 for rinsing the mixing chamber 5 from the first to third components. The rinse medium can be water. The rinse injection unit can inject the rinse medium into the mixing chamber 5 at an arbitrary position along the mixing section 6. Additionally or alternatively, one injection unit can be used for injecting a rinse medium.

In the embodiment of FIG. 1B, a fourth injection unit 7d is present for injecting a fourth component. This is arranged at an injection point 20d which is at the same height as the injection point 20c of the third injection unit 7c. The injection point 20d can lie opposite the injection point 20c on the wall 19 with respect to the central axis 10. Consequently, the fourth component is injected at the same position 20c as the third component along the mixing section 6. According to embodiments not shown, the fourth injection unit 7d can be arranged along the mixing section 6 in front of the third position, in particular between the second position and the third position.

The injection units can comprise a fifth injection unit (not shown) for injecting a fifth component at a fifth position, which is arranged along the mixing section in front of the third position, in particular between the second position and the third position, for example behind the fourth position. The fourth component can in particular be a booster for the third component. The fifth component can in particular be water. According to embodiments, a plurality of first, second, third, fourth and/or fifth injection units can also be present.

The first to third injection units 7a, 7b, 7c are each configured to inject a fluid. According to embodiments, the second injection unit 7b injects, as a component, a gas or a gas mixture, for example air, into the mixing chamber 5. The first component 7a injects, as a second component, a polyol and the third injection unit 7b injects, as a component, a polyisocyanate, or vice versa.

At least one of the injection units 7a, 7b, 7c can be formed removably from the wall 19. This is illustrated in FIG. 1A for the injection unit 7c. As a result, it is possible to offset and attach to another injection point, for example the injection point 20c′. As a result, it is possible to inject the third component flexibly at a plurality of positions Pc, Pc′ along the mixing section 6.

The application device 1 further has a first pressure sensor (not shown) for measuring a pressure in the region of the mixing chamber 5 which is adjacent to the first section 2a of the mixing tube 2. The first pressure sensor can alternatively or additionally be configured to measure a pressure at a position along the mixing section 6 in the region of the first position Pa or at a position between the first position Pa and the second position Pb.

In addition, the application device 1 can have a second pressure sensor (not shown) for measuring a pressure in the region of the mixing chamber 5 which is adjacent to the second section 2b of the mixing tube 2. The second pressure sensor can alternatively or additionally be configured to measure a pressure at a position along the mixing section 6 in the region of the second position Pb or at a position between the second position Pb and the third position Pc. The application device 1 can further comprise a third pressure sensor (not shown) for measuring a pressure in the region of the mixing chamber 5 adjacent to the second end of the mixing tube 4 and/or adjacent to the third section 2c. The third pressure sensor can alternatively or additionally be configured to measure a pressure at a position along the mixing section 6 in the region of the third position Pc or at a position after the third position Pc and/or between the third position Pc and the second end 4.

The application device 1 further has a mixer 8 arranged at least partially in the mixing chamber 5. The mixer 8 can be arranged completely in the mixing chamber 5. Preferably, a central piece 12 and mixing elements 13 of the mixer 8 can be arranged in the mixing chamber 5. The mixer 8 can be formed as a rotor. The mixer 8 is configured to mix the injected components. For this purpose, the mixer 8 rotates in the mixing chamber 5. The axis of rotation of the mixer 8 is preferably parallel to the central axis of the mixing tube 2 or coincides therewith. To rotate the mixer, the application device 1 can have a rotation device 15, for example an electric motor. The mixer 8 and the mixing tube 2 can have been produced by means of 3D printing.

The mixer 8 mixes the injected components along the mixing chamber 5 or along the mixing section 6. The mixer 8 mixes the injected components on the basis of the sequence in which they are injected at the corresponding positions along the mixing section 6. By mixing the injected components, the multicomponent mixture is produced. For example, the PU foam is produced by mixing polyisocyanate with polyol and air.

The produced multicomponent mixture subsequently emerges independently from the mixing tube 2 and the mixer at the second end 4. This takes place in that the mixing tube 2 is arranged vertically and the material of the multicomponent mixture emerges as a result of gravity. Because the upper first end 3 of the mixing tube 4 is closed and when the components are continuously injected into the mixing space 5, the material of the multicomponent mixture is furthermore pressed out of the mixing tube 5 by the material of the injected components flowing in.

The mixer 8 first mixes the first component and air with one another along the mixing space 5, starting from the first end 3. Next, the mixer 8 mixes the mixture of the first component and air with the third component with one another.

Because the injection point 20c for the third component is set lower than the injection point 20b for air, air is already added to or mixed with the first component in the upper part of the mixing tube 2, without the first component already being mixed with the second component. As a result, clogging of the mixer 8 is prevented.

The first end 3 of the mixing tube 2 can be closed and sealed in particular by a part of the mixer 8. Alternatively or additionally, a seal (not shown) can be provided for closing the first end 3.

The mixer 8 has a central piece 12. The central piece is substantially rotationally symmetrical and preferably has the smallest possible extent in the radial direction, in order to minimize centrifugal forces. The central piece 12 extends along the central axis 10 of the mixing tube 2. An axis of symmetry of the central piece 12 preferably coincides with the central axis 10 of the mixing tube 2. In addition, the axis of symmetry of the central piece 12 coincides with the axis of rotation of the mixer. For example, the central piece 12 is configured as a round or cylindrical rod.

In addition, the mixer 8 has a plurality of mixing elements 13. The mixing elements 13 serve for efficient mixing of the injected components. The mixing elements 13 are arranged on an outer side of the central piece 12, for example a lateral surface thereof. The mixing elements 13 extend in the radial direction of the central piece 12. The mixing elements 13 can be arranged distributed along the central piece 12 and/or with respect to the central axis 10 of the mixing tube 2. In addition, the plurality of mixing elements can be arranged distributed in the circumferential direction of the central piece.

For example, as shown, the mixing elements 13 are each formed as a lamella which is arranged on the lateral surface of the central piece 12, wherein the mixing elements 13 each extend in the radial direction of the central piece 12. The mixing elements 13 can be arranged in a star shape and/or regularly around the central piece 12. However, the disclosure is not restricted thereto. The mixing elements 13 are preferably formed and/or arranged in such a way that no imbalance arises when the mixer 8 is rotated.

In addition, a plurality of mixing elements 16 are provided, which are arranged on the inner side of the wall 19 of the mixing tube 2 and extend counter to the radial direction towards the central axis 10 of the mixing tube 8 into the mixing chamber 5. As shown, the mixing elements 16 are likewise formed as lamellae. As shown, the mixing elements 16 are arranged only in the section 2a of the mixing tube 2, but the disclosure is not restricted thereto.

As shown in FIGS. 1A and 1B, the first injection unit 7a is arranged on the wall 19 in the first section 2a of the mixing tube 2. The first injection unit 7a is configured to inject the first component into a region of the mixing chamber 5 which is adjacent to the first section 2a of the mixing tube 2. In addition, the second injection unit 7b is arranged on the wall 19 in the first section 2a of the mixing tube 2. The second injection unit 7a is configured to inject the first component into a region of the mixing chamber 5 which is adjacent to the first section 2a of the mixing tube 2. The third injection unit 7c is arranged on the wall 19 in the second section 2b of the mixing tube 2. The third injection unit 7c is configured to inject the third component into a region of the mixing chamber 5 which is adjacent to the second section 2b of the mixing tube 2.

As shown in FIG. 2, the first injection unit 7a is arranged on the wall 19 in the first section 2a of the mixing tube 2. The second injection unit 7b is arranged on the wall 19 in the second section 2b of the mixing tube 2. The second injection unit 7c is arranged on the wall 19 in the third section 2c of the mixing tube 2.

The application device 1 further comprises a displacement device 9. The displacement device 9 can displace the mixer 8 along and/or parallel to the central axis 10 of the mixing tube 2 and/or between the first end 3 and the second end 4, which is illustrated in the figures by a vertical double arrow. The displacement device 9 is configured to displace the mixer 8 upwardly and downwardly. The displacement device 9 can be, for example, a lifting cylinder, in particular an electric lifting cylinder or an electro-hydraulic lifting cylinder, or a linear unit with a coil.

The mixer 8 has a plurality of sections 8a, 8b, 8c along the central axis 10 of the mixing tube 8 or along the axis of symmetry of the central piece 12, wherein at least two of the sections 8a, 8b, 8c have mutually different external diameters. The (maximum) extent of the mixer 8 in a plane which comprises the radial direction of the mixing tube 2 can be seen as the external diameter of the mixer 8, wherein the mixing elements 13 are taken into account for the extent of the mixer 8.

As shown in FIGS. 1A and 1B, the mixer 8 has an external diameter in a first section 8a which is greater than the external diameter in a second section 8b. The first section 8a is arranged closer to the first end 3 than the second section 8b along the central axis 10 of the mixing tube 2.

As shown in FIG. 2, the mixer further has a third section 8c which is arranged closer to the second end 4 of the mixing tube 2 than the second section 8b of the mixer along the central axis 10 of the mixing tube 2. The third section 8c has a larger external diameter than the first section 8a and the second section 8b. The different external diameters can be achieved in a simple manner by the mixing elements 13 extending differently far in the radial direction.

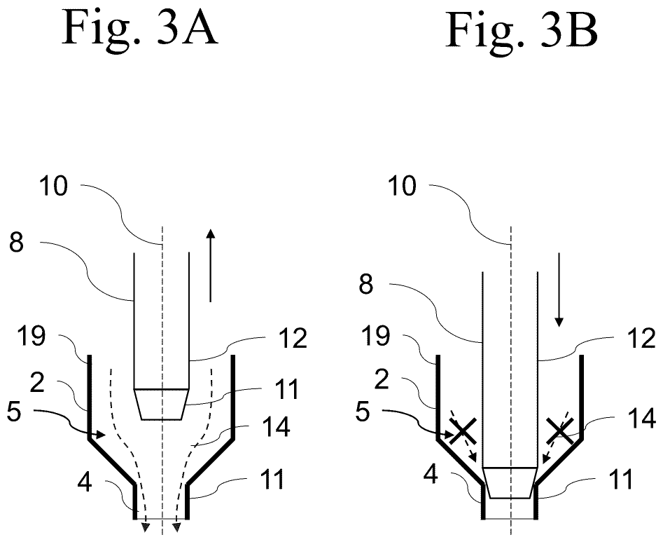

The displacement of the mixer 8 is described with reference to FIGS. 3A to 5B. FIGS. 3B to 5A show schematic cross-sectional views of the second end 3 of the mixing tube 2 and the mixer 8 in different positions of an application device of various embodiments of the disclosure.

The mixer 8 can be displaced along the mixing tube 2 between a first position and a second position. The second position can be closer to the second end 3 than the first position along the mixing tube 2. On the other hand, the first position can be closer to the first end 3 than the second position along the mixing tube 2.

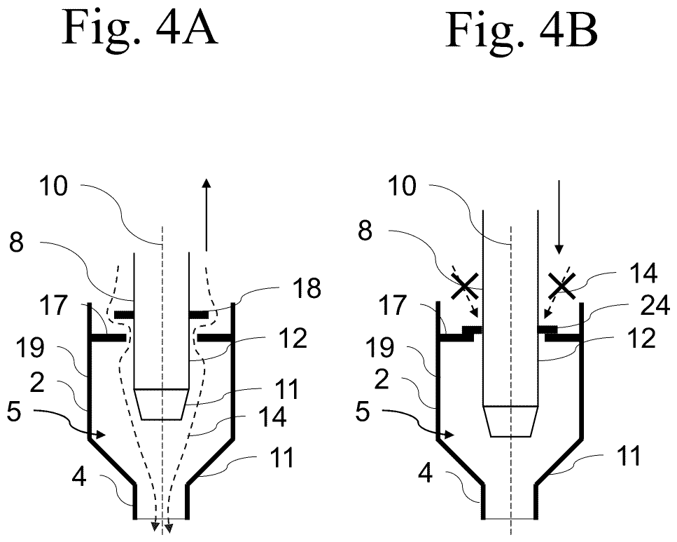

According to a first embodiment, the mixer 8 for producing the multicomponent mixture and for discharging the multicomponent mixture from the mixing tube 2 can be located in the first position. For closing the second end 4 against an unwanted leakage or dripping of the multicomponent mixture from the mixing tube 2, the mixer 8 can be located in the second position. For example, FIGS. 1A, 1B and 2, and also FIGS. 3A and 4A show the mixer 8 in the first position. In this position, a material flow 14 of the multicomponent mixture from the mixing tube 2 via the second end 4 is enabled.

The mixer 8 can be displaced from the first position in the direction of the second end 4 of the mixing tube 2 into the second position. For example, FIGS. 3B and 4B show the mixer 8 in the first position. This displacement has the effect that the mixing tube 2 is sealed with respect to a material flow 14 of the injected components and/or of the multicomponent mixture from the second end 4.

The mixing tube 2 can comprise at least one sealing element 17. The sealing element 17 is arranged in the region of the second end 4. The mixer 8 can likewise comprise a sealing element 18. A displacement of the mixer 8 towards the second end 4 into the second position has the effect that a sealing element 18 of the mixer 8 comes into contact with the sealing element 17 of the mixing tube 2 and the mixing tube 2 is thereby sealed.

As shown in FIGS. 3A and 3B, the sealing element 17 is formed as a conical seat. Here, the sealing element 17 is formed by the second end 4 itself. An end 11 of the mixer 8 forms the sealing element 18, which is formed conically or as a truncated cone on its outer side. According to embodiments not shown, the mixer 8 can have a needle-shaped or pointed end 11. The second end 4 of the mixing tube 2 and the end 11 of the mixer 8 thus form a needle valve.

As shown in FIGS. 4A and 4B, the sealing element 17 is formed as a ring which extends from the inner side of the wall 19 of the mixing tube 2 in the radial direction towards the central axis 10. The sealing element 24 of the mixer 8 is likewise formed as a ring which extends in the radial direction of the mixer 8 from a lateral surface of the central piece 12. In the radial direction, the sealing element 18 overlaps with the sealing element 17.

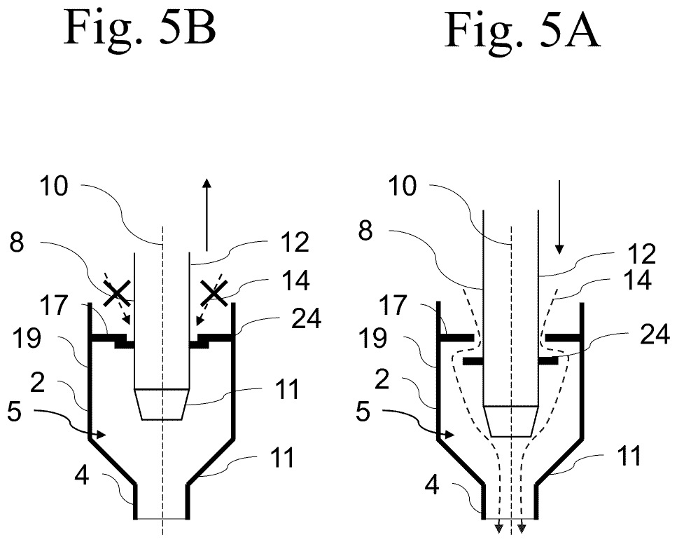

The embodiment of the application device shown in FIGS. 5A and 5B is constructed similarly to that in FIGS. 4A and 4B, with the following difference: the position of the sealing element 17 and of the sealing element 18 with respect to the second end 4 of the mixing tube 2 is reversed. The mixer 8 for producing the multicomponent mixture and for discharging the multicomponent mixture from the mixing tube 2 is thus located in the second position. For closing the second end 4 against an unwanted leakage of the multicomponent mixture from the mixing tube 2, the mixer 8 is located in the first position. For example, FIG. 5B shows the mixer 8 in the second position. In this position, a material flow 14 of the multicomponent mixture from the mixing tube 2 via the second end 4 is enabled.

The mixer 8 can be displaced from the second position into the first position. For example, FIG. 5A shows the mixer 8 in the first position. This displacement has the effect that the mixing tube 2 is sealed with respect to a material flow 14 of the injected components and/or of the multicomponent mixture from the second end 4.

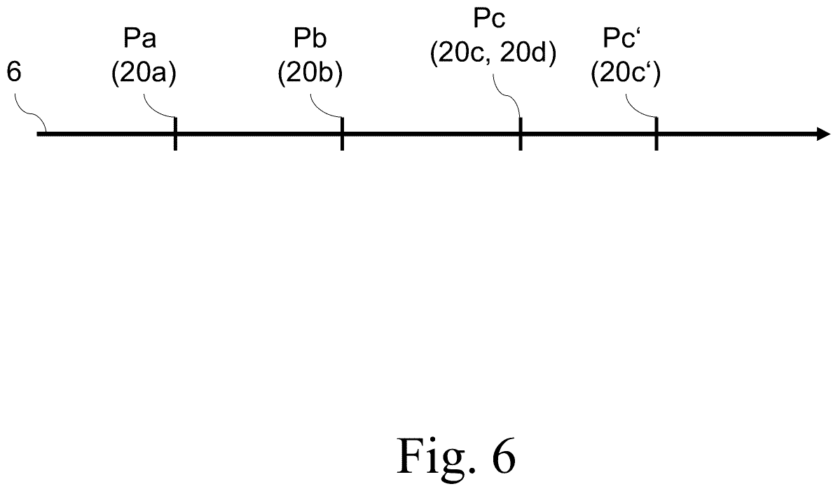

FIG. 6 shows a schematic view of a mixing section of embodiments of the disclosure.

As explained with reference to the preceding figures, the injection units 7a, 7b, 7c, 7d inject the corresponding components into the mixing chamber 5 via corresponding injection points 20a, 20b, 20c, 20c′, 20d. Along the mixing chamber 5, the mixer 8 mixes the corresponding components starting from the first end 3 of the mixing tube 2 towards the second end 4 of the mixing tube 2 in the sequence in which they are injected into the mixing chamber 5. The mixing chamber 5 accordingly defines a mixing section 6 starting from the first end 3 of the mixing tube 2 towards the second end 4 of the mixing tube 2. The mixing section 6 thus serves for the logical or abstract description of the injection sequence of the components into the mixing chamber 5, independently of the detailed geometry of the mixing tube 2 and/or of the mixer 5.

The mixing section 6 can be regarded as an arrow or vector with the first end 3 as the origin and the second end 4 as the tip. The mixing section 6 can be regarded as a course of the central axis 10 of the mixing tube starting from the first end 3 towards the second end 4. If the respective injection points 20a, 20b, 20c, 20c′, 20d are projected onto the central axis 10 of the mixing tube 2, corresponding positions Pa, Pb, Pc, Pc′ result along the mixing section 6, as illustrated in FIG. 6 for the embodiments of FIGS. 1A, 1B and 2.

If the injection points are located at different positions along the central axis 10, or at different heights on the wall 19 of the mixing tube, different positions result therefrom along the mixing section 6. This is the case, for example, for the injection points 20a, 20b, 20c, 20c′ or the positions Pa, Pb, Pc, Pc′. If, on the other hand, the injection points are located at the same position along the central axis 10, or at the same height on the wall 19 of the mixing tube, the same position results therefrom along the mixing section 6. This is the case, for example, for the injection points 20c, 20d and the position Pc. As shown in FIG. 1A, the injection points can be located at the same height along the tube wall 19, but at different positions along the circumference of the tube wall 19.

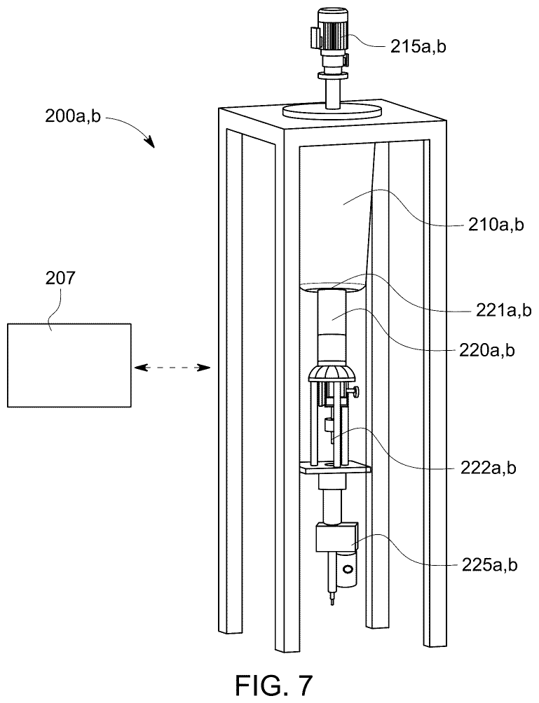

FIG. 7 shows a device for material treatment 200 (also referred to as material treatment device herein). In FIG. 1, the material treatment device is denoted by the reference sign 200a, b, since a first device 200a and a second device 200b can be present. This is analogously valid for all elements of the material treatment device. A material treatment device 200 is described below, wherein the description can be valid for a first material treatment device 200a and for a second material treatment device 200b.

The material treatment device 200 comprises a material container 210 and a pump device 220. The material container 210 is configured to treat a material M. The material M can be one of the first, third, fourth and fifth components. In order to treat the material M, the material container 210 can be heatable. For this purpose, the material container 210 can comprise a heating device (not shown in FIG. 1). The temperature in the material container 210 can be at least 10° C., preferably at least 30°, above the ambient temperature of the material container 210. Alternatively or additionally, a pressure of less than 1.0 bar can prevail in the material container 210. In order to provide a negative pressure, the material container 210 can comprise a negative pressure unit. Alternatively or additionally, the material container 210 can be configured to stir or move or degas the material M. For this purpose, the material container 210 can comprise an agitator 11. The agitator 11 can be moved or driven by a drive 215.

The material M can be a liquid (at 20° C. and 1 bar). The material M can be a suspension. The material M can comprise a monomer for the polymerization of polyurethane. In particular, the material comprises a polyol or a polyisocyanate.

The material M can be stored by the material container 210 and pretreated in the material container 210. For example, the material M can be degassed in the material container 210 or set to a defined physical and/or chemical state. As a result, the material can be metered accurately and reproducibly.

The pump device 220 can be arranged downstream of the material container 210. The material M can flow directly or via additional elements, e.g. fluid conducting elements such as tubes or channels, into an inlet 221 of the pump device 220. A pressure of less than 1.0 bar can prevail at the inlet 221 of the pump device 220. In other words, the material M can have a vacuum at the inlet 221 of the pump device 220.

The pressure of the material M can be increased by the pump device 220. In particular, the pressure can be increased from the inlet 221 of the pump device 220 to an outlet 22 of the pump device 220, for example by at least 20 bar, at least 60 bar, at least 200 bar or even at least 300 bar. The material M can be present at the outlet 222 of the pump device 220 at a pressure of at least 20 bar, at least 60 bar, at least 200 bar or even at least 300 bar.

The pump device 220 can be a high-pressure pump. The pump device 220 can be a piston pump. In particular, the pump device 220 is a high-pressure piston pump.

A volume flow of the material (at the outlet 222 of the pump device 220) can be regulated or controlled by the pump device 220.

The material treatment device 200 can comprise a drive 225 for the pump device 220. The drive 225 can be a servo-hydraulic drive. The volume flow and/or mass flow of the material M can be regulated or controlled by the drive 225.

The pump device 220 can be electrically controllable or regulatable.

Material M can be treated in the material container 210 in the material treatment device 200 and introduced into the pump device 220. The pressure of the material M can be increased in the pump device 220, such that the material can be discharged at the outlet 222 of the pump device 220 at a pressure of at least 15 bar.

The material treatment device 200 can be coupled to a control unit 207 or comprise the control unit 207. The control unit 207 can be coupled to the device in a wired or wireless manner. The control unit 207 can be configured to control or regulate the material container 210 and/or the pump device 220. In particular, the control unit 207 is configured to control or regulate the drive 215 of the agitator 211 and/or the drive 225 of the pump device 220. The control unit can be the control unit 107 from FIG. 7.

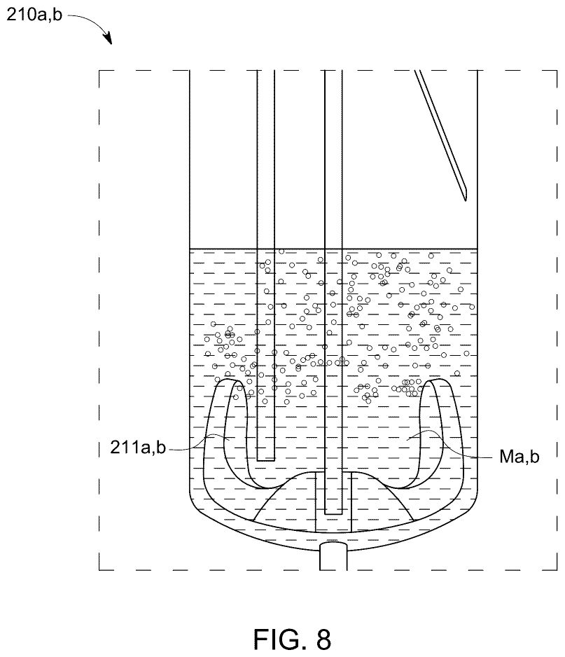

FIG. 8 shows a detailed view of the material container 210. Material M is contained or stored in the material container 210. The material M is treated in the material container 210. For example, a vacuum or a negative pressure for the material M can be provided by the material container 210. Alternatively or additionally, the material M can be heated in the material container 210. Alternatively or additionally, the material M can be stirred or moved in the material container 210, in particular by the agitator 211.

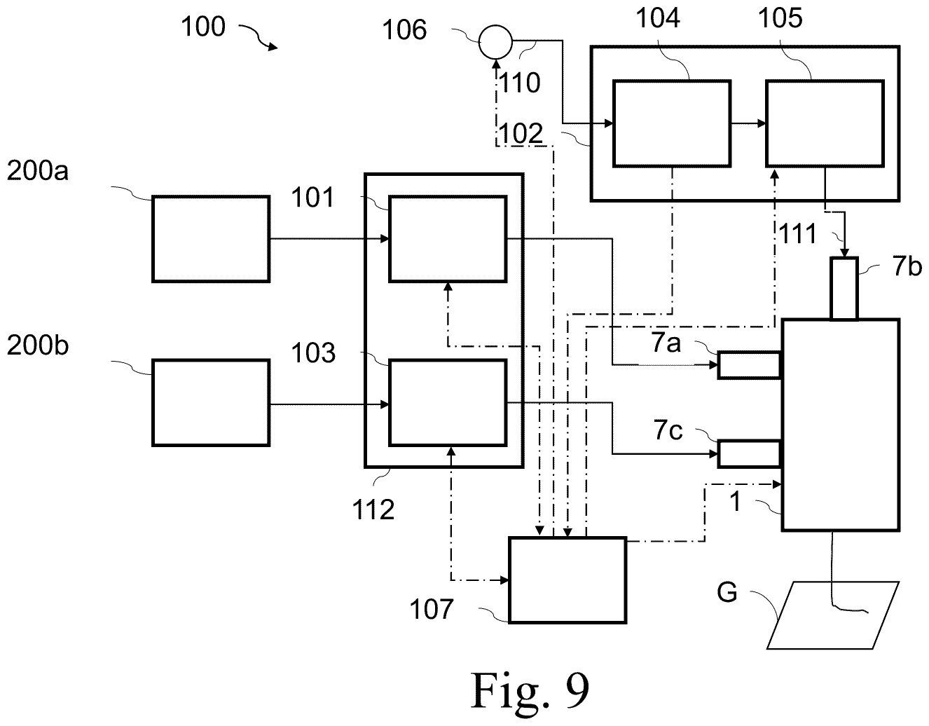

FIG. 9 shows a schematic view of an application system for mixing a plurality of components for producing a multicomponent mixture and for introducing or applying the multicomponent mixture into or onto an object of embodiments of the disclosure.

The application system 100 comprises an application device 1 of embodiments of the disclosure, for example the application device 1 of FIG. 1A.

Furthermore, the application system 100 can comprise at least one first material treatment device 200a. The material treatment device 200a is configured to provide a material flow of the first component. Furthermore, the application system 100 can comprise a second material treatment device 200b. The second material treatment device 200b is configured to provide a material flow of the third component.

The material treatment device 200a can comprise a first material container 210a and a first pump device 220a. The first material container 210a can be configured to treat the first component (corresponds to material Ma in FIG. 8). The first pump device 220a can have a first inlet 221a and a first outlet 222a. The first inlet 221a of the first pump device 220a can be connected in a fluid-communicating manner to the first material container 210a, such that the first material Ma can be introduced from the first material container 210a into the first pump device 20a. The first pump device 220a can be configured to provide the first material Ma at the first outlet 222a of the first pump device 220a at a pressure of at least 15 bar.

The application system 100 can comprise a second material treatment device 200b. The second material treatment device 200b can comprise a second material container 210b and a second pump device 220b. The second material container 210b can be configured to treat the third component (corresponds to material Mb in FIG. 8). The second pump device 220b can have a second inlet 221b and a second outlet 222b. The second inlet 221b of the second pump device 220b can be connected in a fluid-communicating manner to the second material container 210b, such that the second material Mb can be introduced from the second material container 210b into the second pump device 220b. The second pump device 220b can be configured to provide the second material Mb at the second outlet 222b of the second pump device 220b at a pressure of at least 15 bar.

The application device 1 can be connected in a fluid-communicating manner to the first outlet 222a and the second outlet 222b, such that the first component and the third component can be introduced into the application device 1.

Furthermore, the application system 100 comprises a first metering device 101, which is configured to receive the material flow of the first component from the material treatment device 200a, to set a mass flow and/or volume flow of this component, and to provide the material flow to the first injection unit 7a of the application device 1.

In addition, the application system 100 comprises a second metering device 102, which is configured to receive a material flow of the second component, to set a mass flow and/or volume flow of the second component, and to provide the material flow to the second injection unit 7b of the application device 1. For example, the second component is gas or a gas mixture, for example air, and the material flow is a gas flow or air flow.

Furthermore, the application system comprises a third metering device 103, which is configured to receive the material flow of the third component from the second material treatment device 200b, to set a volume flow of this component, and to provide the material flow to the third injection unit 7c of the application device 1.

The first metering device 101 and the third metering device 103 can preferably be contained in a metering device 112, or form the metering device 112. The first metering device 101 and the third metering device 103 can be constructed identically or have identical functions. The metering device 112 can be, for example, a tandem meterer DPL 2001 2KT from Scheugenpflug.

Each of the metering devices can also be configured to set a volume flow of the corresponding components. According to embodiments not shown, the application system 100 can comprise further corresponding devices for material treatment and metering devices for further components, such as a fourth and/or fifth component.

The second metering device 102 comprises a measuring unit 104, for example an air mass sensor or an air quantity sensor. The second metering device 102 further comprises an actuator 105, in particular an air valve, for example a proportional air valve. The measuring unit 104 is configured to receive the air flow from an air supply device 106 of the application system 100 or from an external air supply device 106 and to measure a mass flow and/or a volume flow of the air flow, and to provide the air flow to the actuator 105. The actuator 105 is configured to receive the air flow from the measuring unit 104, to set the mass flow and/or the volume flow of the air flow, and to provide the air flow to the second injection unit 7b. With a proportional air valve, a variable volume flow and/or mass flow of the air flow can be provided.

The air supply device 106 can be, for example, an air pump. The air supply device 106 is configured to provide the air flow at a predefined pressure.

The application system 100 furthermore comprises a first line 110 between the air supply device 106 and the second metering device 102 and a second line 111 between the second metering device 102 and the second injection unit 7a. The lines 110, 111 can be, for example, hoses. The lines 110, 111 serve to conduct the air flow between the air supply device 106, the second metering device 102 and the second injection unit 7a. The second component thus flows in a material flow direction from the air supply device 106 to the metering device 102 to the injection unit 7b.

The application system 100 furthermore comprises measuring units for measuring a pressure. The application system 100 comprises a first line pressure sensor (not shown) which is configured to measure an air pressure in the first line 110. The application system 100 furthermore comprises a second line pressure sensor (not shown) configured to measure an air pressure in the second line 111.

The application system 100 furthermore comprises corresponding fluid conducting elements or lines for conveying the first component from the first material treatment device to the first metering device 101 and to the first injection unit 7a, as well as lines for conveying the second component from the second material treatment device 200b to the third metering device 103 and to the third injection unit 7b. The first component thus flows in a material flow direction from the first material treatment device 200a to the metering device 101 and subsequently to the injection unit 7a. In addition, the third component flows in a material flow direction from the second material treatment device 200b to the metering device 103 and subsequently to the injection unit 7b.

The first material treatment device 200a, the first metering device 101 and the first injection unit 7a are connected in a fluid-communicating manner to one another. The second material treatment device 200b, the third metering device 103 and the third injection unit 7c are connected in a fluid-communicating manner to one another. The air supply device 106, the second metering device 102 and the second injection unit 7b are connected in a fluid-communicating manner to one another.

The lines and the material flow of the first component, the second component and the third component are illustrated in FIG. 9 by means of solid arrows.

The application system 100 is configured to mix the first component and the third component with air only in the mixing chamber 5 of the application device 1. The application system 100 mixes neither the first component nor the third component with air beforehand. In particular, the application system does not mix the first component or the third component with air already in the corresponding material treatment 200a, 200b or upstream of the corresponding metering device 101, 103. The first component is thus not mixed with air upstream of or in the injection unit 7a in a material flow direction from the first material treatment device 200a to the metering device 101 to the injection unit 7a. Correspondingly, the third component is not mixed with air upstream of the injection unit 7b in a material flow direction from the material treatment device 200b to the metering device 103 to the injection unit 7b. The first component and the third component are thus not mixed with gas or air upstream of the application device 1 and not upstream of the corresponding injection units 7a, 7b.

The application system is thus configured to mix the first component with air upstream of the first metering device 101 and upstream of the first injection unit 7a in a material flow direction of the first component. The application system is configured to mix the third component with air upstream of the third metering device 103 and upstream of the third injection unit 7b in a material flow direction of the third component. The first component and the third component are thus injected into the mixing chamber 5 in an air-free or gas-free state.

The application system furthermore comprises a control unit 107. The control unit 107 comprises, for example, a computing unit, in particular a microprocessor. The control unit 107 is configured to control and/or regulate an operation of the application system 100. For this purpose, the control unit 107 is configured to receive measured values or measurement signals from measuring units of the application system, for example the measuring unit 104, the first to third pressure sensors for the mixing chamber 5 and the line pressure sensors. In addition, the control unit 107 is configured to actuate the metering devices 101, 102, 103, the injection units 7a, 7b, 7c, the actuator 105, the air supply device 106, the material treatment devices 200a, 200b. The receiving of measured values and the actuation of the respective units is illustrated in FIG. 9 by dashed single and double arrows.

The system 100 can also be referred to as a system for applying a mixture, in particular for the polymerization of polyurethane.

The control unit 107 is configured to carry out a control step of a method of embodiments of the disclosure.

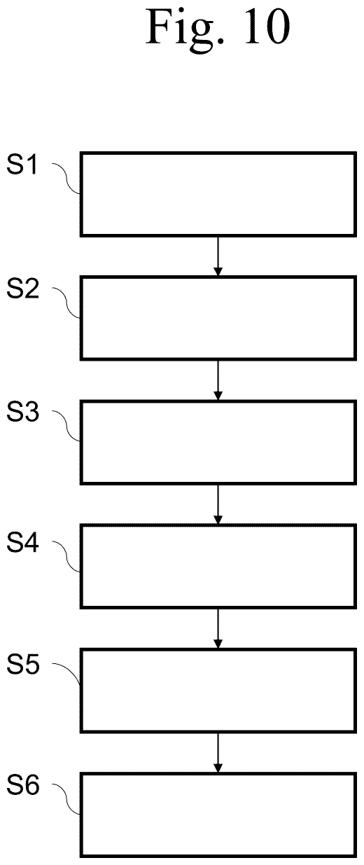

FIG. 10 shows a flow diagram of a method for mixing a plurality of components for producing a multicomponent mixture and for introducing or applying the multicomponent mixture into or onto an object of embodiments of the disclosure. The method can be carried out by means of an application device or an application system of embodiments of the disclosure, for example the application device of FIG. 1A and the application system of FIG. 9. The method comprises the following steps. The steps are carried out at the same time.

A first component is injected by means of a first injection unit into a mixing chamber 5 of a mixing tube with a first end and a second end, S1. Here, the mixing chamber defines a mixing section. The first component is injected into the mixing chamber at a first injection point. The first component is thus injected into the mixing chamber at a first position corresponding to this first injection point along the mixing section.

A second component, for example gas or a gas mixture, in particular air, is injected into the mixing chamber by means of a second injection unit, S2. The second component is injected into the mixing chamber at a second injection point. The second component is injected into the mixing chamber at a corresponding second position along the mixing section. Here, the second position is arranged behind the first position along the mixing section.

The method comprises injecting, S4, a third component into the mixing chamber by means of a third injection unit. The third component is injected into the mixing chamber at a third injection point. The third component is injected into the mixing chamber at a corresponding third position along the mixing section. Here, the third position is arranged behind the second position P along the mixing section.

The method comprises mixing the first to third components along the mixing tube on the basis of the sequence in which the components were injected along the mixing section. The mixing takes place by means of a mixer arranged in the mixing chamber. The mixing comprises mixing, S3, the first component with the second component. The method comprises mixing, S5, the mixture of the first component and the second component with the third component for producing the multicomponent mixture comprising the first, second and third components.

The method furthermore comprises discharging, S6, the multicomponent mixture from the mixing tube through the second end. Furthermore, the method comprises applying the multicomponent mixture onto the object.

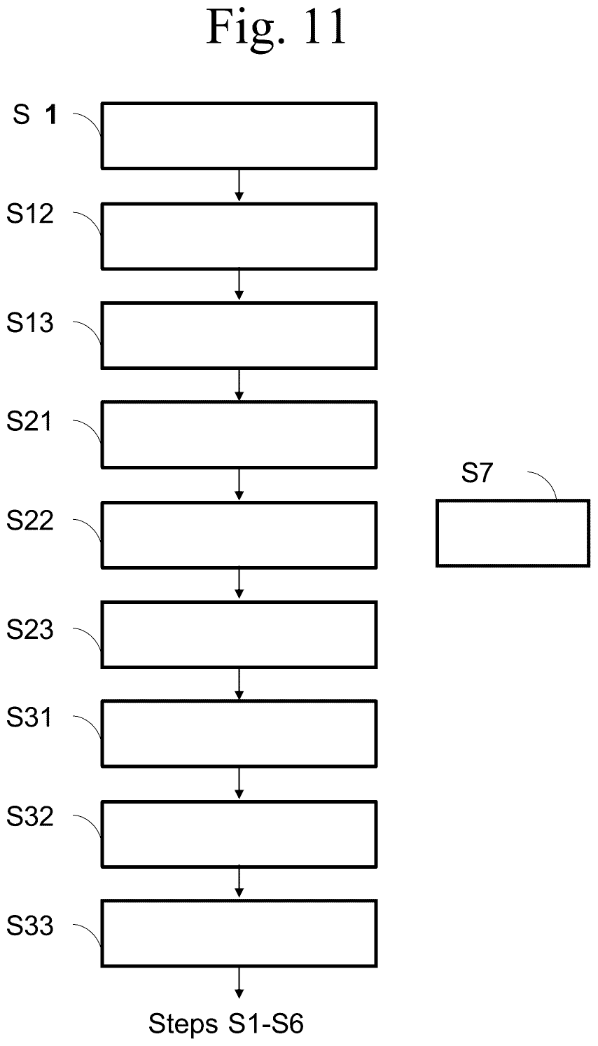

FIG. 11 shows a flow diagram of a method for mixing a plurality of components for producing a multicomponent mixture and for introducing or applying the multicomponent mixture into or onto an object of further embodiments of the disclosure. The method can be carried out by means of an application system of embodiments of the disclosure, for example the application system of FIG. 9. The method comprises the following steps. The steps are carried out at the same time.

A material flow of a first component is provided by means of a first device for material treatment to a first metering device, S11. By means of the first metering device, a mass flow and/or volume flow of the first component is set, S12, and the material flow is provided to a first injection unit, S13.

An air flow is provided by means of an air supply device to a second metering device, S21. By means of the second metering device, a mass flow and/or volume flow of the air flow is set, S22, and the air flow is provided to a second injection unit, S23.

A material flow of a third component is provided by means of a second device for material treatment to a third metering device, S31. By means of the third metering device, a mass flow and/or volume flow of the third component is set, S32, and the material flow is provided to a third injection unit of the application device, S33.

The method of FIG. 11 furthermore comprises the method with the steps S1-S6 of FIG. 10.

The method furthermore comprises a control, S7, by means of a control unit.

The control can comprise actuating a rotation device for the mixer and/or the first metering device and/or the second metering device, in particular a measuring unit and an actuator, and/or the third metering device and/or the air supply device.

The control can comprise controlling an air pressure, in particular in a line for conducting the air flow and/or at the second injection point for the air, in such a way that the second component is injected into the mixing chamber at a greater pressure than the first component and/or than the third component, or that the air pressure is greater than a pressure in the mixing chamber. Preferably, the difference can be 1 bar or more. The air pressure can be produced, for example, by adjusting an air pressure by means of the air supply device and/or by means of the actuator of the second metering device.

The control can furthermore comprise controlling the ratio of the mass flow of the air flow to the mass flow of the first component and/or controlling or setting the ratio of the mass flow of the air flow to the mass flow of the third component. Here, these can preferably be the mass flows of the material flows of the components which are injected into the mixing chamber.

A setpoint value for the ratio can be predefined by the control unit or by an external system or a user of the application device. The setpoint value can be predefined by a mathematical function. As a result, it is ensured that the same amount of air is always added to the material of the first component and to the material of the third component. In other words, it is ensured that the same predefined amount of air is always added to the PU foam. The ratio can be produced, for example, by: setting the mass flow of the first component by means of the first metering device and/or setting the mass flow of the third component by means of the third metering device and/or setting the mass flow and/or volume flow of the air by means of the second metering device, and/or setting the rotational speed of the mixer by means of a rotation device of the mixer, and/or setting an air pressure by means of the air supply device.

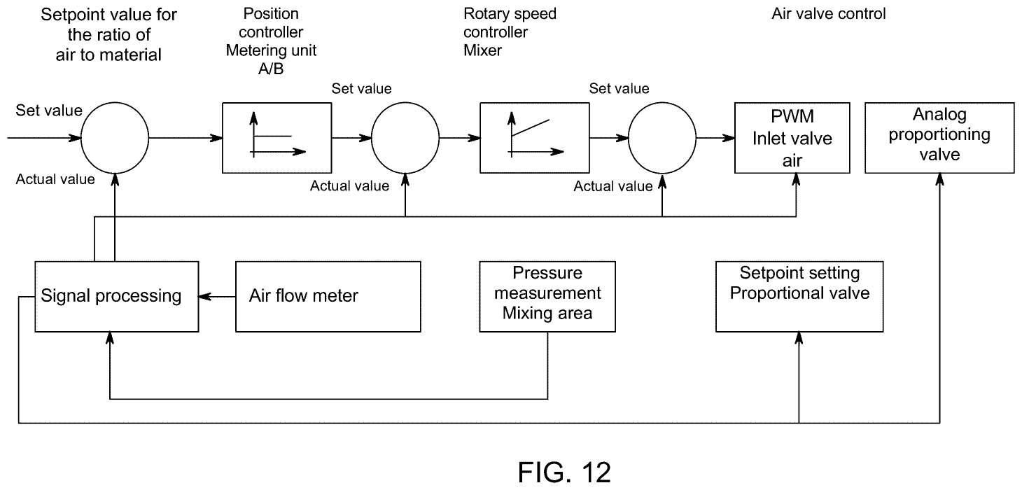

FIG. 12 shows a diagram for illustrating a control step of a method for mixing a plurality of components for producing a multicomponent mixture and for introducing or applying the multicomponent mixture into or onto an object of embodiments of the disclosure.

An air quantity meter as measuring unit measures an amount or a mass flow of the air injected into the mixer. In addition, a pressure in the mixing chamber is measured via a pressure sensor. On the basis of this, signal processing is carried out, for example by means of the control unit. On the basis of the signal processing, actual values for the “air-to-material ratio”, an actual value for a position controller of the first metering device for the first component and/or a position controller of the third metering device for the third component, an actual value for the rotational speed of the mixer, and an actual value for a PWM control of the inlet valve of the second injection unit for the air flow are predefined. In addition, a setpoint value for the proportional valve of the second metering device for the air flow is predefined on the basis of the signal processing. The proportional valve may be analogous.

The “air-to-material ratio” describes, for example, a ratio of the injected amount of air or of an injected mass flow of the air to the injected amount of the first component (A in FIG. 12) or to the injected mass flow of the first component into the mixing chamber.

A setpoint value for the position controllers of the first or third metering device results from the setpoint value for the “air-to-material ratio”. A setpoint value for the rotational speed of the mixer furthermore results from the setpoint value for the “air-to-material ratio”. A setpoint value for the actuation of the inlet valve furthermore results from the setpoint value for the “air-to-material ratio”.

The position of the first or third metering device is regulated on the basis of the setpoint value and the actual value for the “air-to-material ratio”. The position can describe, for example, an opening angle of a metering unit of the metering device. However, the position can also be set as a function of a desired amount or a desired material flow of the PU foam.

The rotational speed of the mixer is regulated on the basis of the setpoint value and the actual value for the rotational speed. For example, the rotational speed is regulated proportionally to a difference between the setpoint value and the actual value.

Furthermore, the inlet valve is actuated on the basis of the setpoint value and the actual value for the PWM control of the inlet valve.

In addition, the proportional valve is actuated.

The air supply is regulated proportionally to the material flow and the mixer rotational speed, such that it is ensured that the same amount of air is always added to the material. The amount of air is determined via the proportional valve. An air quantity meter is used as measuring instrument. The air pressure supplied should always be at least 1 bar greater than the pressure in the mixing chamber. It can thus be prevented that the material of the first component or material of the third components flows into the injection unit and/or the lines for the air flow and clogs or contaminates the latter. According to embodiments, the amount of air is regulated via the air quantity meter. The proportional valve regulates the air pressure.

### REFERENCE SIGNS LIST

1 Application device
2 Mixing tube
2a, 2b, 2c Sections of the mixing tube
2d, 2e Transition sections of the mixing tube
3 First end of the mixing tube
4 Second end of the mixing tube
5 Mixing chamber
6 Mixing section
7a, 7b, 7c Injection units
8 Mixer
8a, 8b, 8c Sections of the mixer
9 Displacement device
10 Central axis of the mixing tube
11 End of the mixer
12 Central piece of the mixer
13 Mixing elements of the mixer
14 Material flow
15 Rotation device
6 Mixing elements of the device
17 Sealing element of the mixing tube
18 Sealing element of the mixer
19 Wall of the mixing tube
20, 20b, 20c, 20c′, 20d Injection points
100 Application system
101 First metering device
102 Second metering device
103 Third metering device
104 Measuring unit
105 Actuator
106 Air supply device
107 Control unit
110 First line
111 Second line
112 Metering device
200a,b Device for material treatment
207 Control device
210a,b Material container
211a,b Agitator
215a,b Drive
220a,b Pump device
221a,b Inlet
222a,b Outlet
225a,b Drive

What is claimed is:

1. Application device for mixing a plurality of components for producing a multicomponent mixture, in particular a polyurethane foam, and for introducing and/or applying the multicomponent mixture into and/or onto an object, in particular a lithium-ion battery, comprising:
a mixing tube with a first closed end and a second end for discharging the multicomponent mixture from the mixing tube, wherein the mixing tube comprises a mixing chamber,
wherein the mixing tube has a plurality of sections, wherein a wall of the mixing tube of at least two of the plurality of sections has mutually different internal diameters,
a plurality of injection units, each configured to inject a corresponding one of the plurality of components into the mixing chamber,
a mixer arranged in the mixing chamber, which mixer is configured to mix the injected components with one another along the mixing tube.

2. Application device according to claim 1, the plurality of sections comprising:
a first section, which is arranged at or adjacent to the first end,
a second section, which is arranged between the first section and the second end along the central axis,
wherein in particular the wall in the first section has a larger internal diameter than in the second section.

3. Application device according to claim 2, the plurality of sections further comprising:
a third section, which is arranged between the second section and the second end along the central axis,
wherein in particular the wall in the third section has a smaller internal diameter than in the first section and/or in the second section, or wherein in particular the wall (19) in the third section has a larger internal diameter than in the first section and/or in the second section.

4. Application device according to one claim 1, the mixing tube further comprising a further transition section in each case between two of the plurality of sections, wherein the wall in each of the transition sections has a variable, preferably a linearly variable, internal diameter along the central axis.

5. Application device according to claim 1, further comprising at least one pressure sensor, wherein preferably at least one pressure sensor is provided for at least one of the plurality of sections of the mixing tube, which pressure sensor is configured to measure a pressure in the region of the mixing chamber adjacent to the respective section.

6. Application device according to claim 5, the at least one pressure sensor comprising:
a first pressure sensor configured to measure a pressure in the region of the mixing chamber adjacent to the first end of the mixing tube and/or adjacent to the first section of the mixing tube,
a second pressure sensor configured to measure a pressure in the region of the mixing chamber adjacent to the second section of the mixing tube, and
a third pressure sensor configured to measure a pressure in the region of the mixing chamber adjacent to the second end of the mixing tube and/or adjacent to the third section.

7. Application device according to claim 1, wherein the mixing tube is formed to be straight and/or is arranged vertically,
wherein the inner side of the wall of the mixing tube is rotationally symmetrical about the central axis.

8. Application device according to claim 1, further comprising a displacement device, preferably an electric lifting cylinder or an electro-hydraulic lifting cylinder, which is configured to displace the mixer along a central axis of the mixing tube and/or between the first end and the second end in such a way that the mixing tube is sealed with respect to a material flow of the injected components and/or of the multicomponent mixture from the second end of the mixing tube and/or towards the second end.

9. Application device according to claim 1, further comprising a rotation device, preferably an electric motor, particularly preferably a servo electric motor, configured to rotate the mixer about an axis of rotation which coincides with the central axis of the mixing tube.

10. Application device according to claim 1, wherein the mixer has a plurality of sections, wherein at least two of the plurality of sections have mutually different external diameters.

11. Application device according to claim 10, the plurality of sections of the mixer comprising:
a first section,
a second section, wherein the first section is arranged closer to the first end than the second section (8b),
a third section, wherein the third section is arranged closer to the second end than the first section and/or than the second section,
wherein in particular the first section has a larger external diameter than the second section,
wherein in particular the third section has a larger external diameter than the first section (8a) and/or the second section, or wherein the third section has a smaller external diameter than the first section and/or the second section.

12. Application device according to claim 1, further comprising at least one mixing element which is arranged on the wall of the mixing tube and extends into the mixing chamber, wherein the at least one mixing element is formed as a ring, or wherein the at least one mixing element is formed as a lamella, tine, hook or rod, or wherein the at least one mixing element is formed as a regular or irregular structure.

13. Application device according to claim 1, the plurality of injection units comprising:
at least one first injection unit which is arranged on a wall of the mixing tube in the first section, configured to inject a first component into a region of the mixing chamber adjacent to the first section of the mixing tube, and/or
at least one second injection unit which is arranged on a wall of the mixing tube in the second section of the mixing tube, configured to inject a second component into a region of the mixing chamber adjacent to the second section of the mixing tube, and/or
at least one third injection unit (7c) is arranged on a wall (19) of the mixing tube in the third section of the mixing tube, configured to inject a third component into a region of the mixing chamber adjacent to the third section of the mixing tube.

14. Application system for mixing a plurality of components for producing a multicomponent mixture and for introducing and/or applying the multicomponent mixture into and/or onto an object,
comprising an application device according to claim 1.
